(19) United States
(12) Patent Application Publication
(10) Pub. No.: US 2016/0033408 A1
(43) Pub. Date: Feb. 4, 2016

(54) DETECTING APPARATUS

(71) Applicant: PANASONIC INTELLECTUAL PROPERTY MANAGEMENT CO., LTD., Osaka-shi, Osaka (JP)

(72) Inventor: Kenji NARUMI, Osaka (JP)

(21) Appl. No.: 14/425,465

(22) PCT Filed: Aug. 8, 2014
(86) PCT No.: PCT/JP2014/004155

§ 371 Date: Mar. 3, 2015

(30) Foreign Application Priority Data
Aug. 30, 2013 (JP) 2013-179035

(51) Int. Cl. G01N 21/64

(52) U.S. Cl. CPC G01N 21/648; G01N 2201/06113; G01N 2201/0683

(57) ABSTRACT

The present application discloses a detecting apparatus including: a light source for emitting excitation light; a storage portion in which a specimen is stored; a metal film which receives the excitation light to cause evanescent light for illuminating the specimen; a modulator for adjusting an incident angle of the excitation light on the metal film; a driver for generating a driving signal for driving the modulator; a detector for outputting a fluorescence signal in correspondence to intensity of fluorescence generated from the specimen under irradiation of the evanescent light; and an extractor which extracts a signal component from the fluorescence signal, the signal component deriving from the specimen. The incident angle changes in response to a change of the driving signal. The extractor extracts a synchronous signal component as the signal component, the synchronous signal component changing in synchronization with the change of the driving signal.

### TECHNICAL FIELD

The present invention relates to a detecting apparatus which detects detection target substances on the basis of the surface plasmon fluorescence spectroscopy (SPFS method).

### BACKGROUND ART

In the field of biotechnology, various techniques have been proposed to highly sensitively detect and/or measure a very small amount of substances. The surface plasmon fluorescence spectroscopy (hereinafter referred to as SPFS method) for detecting fluorescence intensified by the surface plasmon resonance is known as one of the highly sensitive detection techniques.

The SPFS method uses a light source which emits a laser beam as excitation light. The laser beam enters a metal thin film attached to a surface of a prism under the total reflection condition. An incident angle of the laser beam on the metal thin film is adjusted so that surface plasmon resonance happens to a surface of the metal thin film. The surface plasmon resonance causes an intensified electric field of evanescent light.

Detection target substances are labeled by fluorescent substances. A specimen containing the detection target substances is situated near a surface of the metal thin film. The electric field strengthened under the surface plasmon resonance may intensify fluorescence generated from the detection target substances. The SPFS method is a technique for detecting and/or measuring the intensified fluorescence from the detection target substances.

The incident angle to cause the most intensified electric field of the evanescent light is called the resonance angle. The resonance angle depends on a wavelength of the excitation light, a refractive index of the prism, a refractive index of the metal thin film, a thickness of the metal thin film and a refractive index of the detection target substances existing near the metal thin film.

If a measuring person measures incident angle dependency about intensity of reflected light from the metal thin film, the measuring person may observe rapid attenuation of the intensity of the reflected light near the resonance angle. If the measuring person measures incident angle dependency about intensity of the fluorescence from the detection target substances, the measuring person may observe a rapid increase in the intensity of the fluorescence near the resonance angle (called the resonance curve). These phenomena are well known.

The SPFS method uses a detector to detect fluorescence from detection target substances. In actual measurement, the detector detects not only the fluorescence deriving from the detection target substances but also light (unnecessary light) deriving from other factors. Autofluorescence generated inside an optical component such as a prism when excitation light passes through the optical component is exemplified as a factor which causes the unnecessary light. If the excitation light scattered inside an apparatus used in the SPFS method is irradiated on the detection target substances existing in a position distant from a surface of the metal thin film, fluorescence generated from the detection target substances existing in the position distant from the surface of the metal thin film also becomes the unnecessary light.

As described above, the unnecessary light caused by various factors may result in measurement errors and noise. Therefore, in order to improve sensitivity for detecting the detection target substances with the SPFS method, it is important to reduce the unnecessary light which enters to the detector.

Patent Document 1 proposes techniques for making the unnecessary light less influential. According to Patent Document 1, a polarization direction of excitation light is modulated. Fluorescence signals output from a detector are subjected to synchronous detection with modulation signals for the polarization direction.

If the unnecessary light includes components depending on the polarization direction of the excitation light, the techniques may not sufficiently exclude influence of the unnecessary light. In this case, the techniques may not accurately measure intensity of fluorescence.
Patent Document 1: JP 2011-209097 A

### SUMMARY OF INVENTION

It is an object of the present invention to provide a detecting apparatus which may accurately measure intensity of fluorescence.

A detecting apparatus according to one aspect of the present invention includes: a light source configured to emit excitation light; a storage portion in which a specimen is stored; a metal film which receives the excitation light to cause evanescent light for illuminating the specimen; a modulator configured to adjust an incident angle of the excitation light on the metal film; a driver configured to generate a driving signal for driving the modulator; a detector configured to output a fluorescence signal in correspondence to intensity of fluorescence generated from the specimen under irradiation of the evanescent light; and an extractor configured to extract a signal component from the fluorescence signal, the signal component deriving from the specimen. The incident angle changes in response to a change of the driving signal. The extractor extracts a synchronous signal component as the signal component, the synchronous signal component changing in synchronization with the change of the driving signal.

The detecting apparatus may accurately measure intensity of the fluorescence.

Objects, features and advantages of the present invention are made more obvious by the following detailed description and the accompanying drawings.

### BRIEF DESCRIPTION OF DRAWINGS

FIG. 1 is a schematic block diagram of a detecting apparatus according to the first embodiment.

FIG. 2A is a schematic graph of a driving signal of the detecting apparatus shown in FIG. 1 (the second embodiment).

FIG. 2B is a graph schematically showing a fluorescence signal processed by an extractor of the detecting apparatus shown in FIG. 1 (the second embodiment).

FIG. 2C is a schematic graph of a detection signal output by the extractor of the detecting apparatus shown in FIG. 1 (the second embodiment).

FIG. 3 is a schematic view of a detecting apparatus according to the third embodiment.

FIG. 4 is a schematic enlarged diagram of the detecting apparatus shown in FIG. 3 (the fourth embodiment).

FIG. 5A is a graph schematically showing a relationship between an incident angle and amplitude of a fluorescence signal (the fourth embodiment).

FIG. 5B is a graph schematically showing a relationship between an average incident angle and a detection signal (the fourth embodiment).

FIG. 5C is a graph showing calibration curve data stored by a calculator of the detecting apparatus shown in FIG. 3 (the fourth embodiment).

FIG. 6 is a schematic view of a detecting apparatus according to the fifth embodiment.

FIG. 7 is a schematic view of a detecting apparatus according to the sixth embodiment.

FIG. 8 is a schematic block diagram of a detecting apparatus according to the seventh embodiment.

FIG. 9A is a schematic view of a detecting apparatus according to the eighth embodiment.

FIG. 9B is a schematic view of the detecting apparatus shown in FIG. 9A.

FIG. 10A is a graph showing detection signals calculated on the basis of experimental results (the ninth embodiment).

FIG. 10B is a graph showing detection signals calculated on the basis of experimental results (the ninth embodiment).

FIG. 10C is a graph showing detection signals calculated on the basis of experimental results (the ninth embodiment).

FIG. 10D is a graph showing detection signals calculated on the basis of experimental results (the ninth embodiment).

FIG. 11A is a schematic view of a detecting apparatus according to the tenth embodiment.

FIG. 11B is a schematic view of the detecting apparatus shown in FIG. 11A.

FIG. 12 is a graph showing an integrated value.

FIG. 13A is a graph showing detection signals calculated on the basis of experimental results (the eleventh embodiment).

FIG. 13B is a graph showing detection signals calculated on the basis of experimental results (the eleventh embodiment).

FIG. 13C is a graph showing detection signals calculated on the basis of experimental results (the eleventh embodiment).

FIG. 13D is a graph showing detection signals calculated on the basis of experimental results (the eleventh embodiment).

FIG. 14A is a schematic view of a detecting apparatus according to the twelfth embodiment.

FIG. 14B is a schematic view of the detecting apparatus shown in FIG. 14A.

FIG. 15 is a schematic view of the detecting apparatus of Patent Document 1.

FIG. 16 is a graph showing characteristics of a detection signal generated by a signal processor of the detecting apparatus shown in FIG. 15.

### DESCRIPTION OF EMBODIMENTS

Various embodiments of exemplary detecting apparatuses are described with reference to the drawings. In the following embodiments, the same components are denoted by the same reference numerals and signs. For clarification of explanation, redundant description is omitted. Configurations, arrangements or shapes shown in the drawings and descriptions about the drawings are only to make principles of the embodiments easily understood. Therefore, the principles of the following embodiments are not limited to the configurations, the arrangements or the shapes shown in the drawings and descriptions. Directional terms such as “upper”, “lower”, “left” and “right” are simply for the purpose of clarification of explanation. Therefore, these terms should not be limitedly interpreted.

### Problems of Conventional Techniques Found by Inventors

The present inventors studied the conventional detection techniques and found various problems. Detecting apparatuses explained by the following various embodiments have been developed in order to solve these problems.

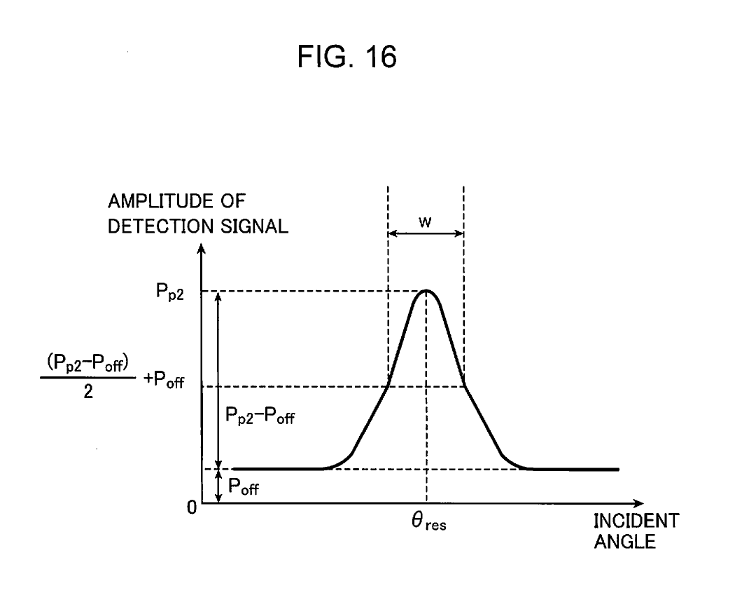

FIG. 15 is a schematic view of a detecting apparatus 900 of Patent Document 1. Problems of the detecting apparatus 900 are described with reference to FIG. 15.

The detecting apparatus 900 includes a light source 910, a polarization modulator 920, a prism 930, a metal thin film 940, a specimen cell 950, a detector 960, a polarization controller 970 and a signal processor 980. The light source 910 emits excitation light PL to the polarization modulator 920. The excitation light PL passes through the polarization modulator 920 and enters the prism 930. The prism 930 refracts the excitation light PL. The metal thin film 940 is formed on a surface of the prism 930. The metal thin film 940 is situated between the prism 930 and the specimen cell 950. The excitation light PL refracted by the prism 930 propagates toward the metal thin film 940. The metal thin film 940 totally reflects the excitation light PL.

A specimen (not shown) is stored in the specimen cell 950. The specimen includes detection target substances (not shown), which are labeled with fluorescent substances (not shown). As a result of irradiation of the excitation light PL on the metal thin film 940, fluorescence FL is generated from the detection target substances existing near the metal thin film 940.

The detector 960 receives the fluorescence FL to generate a fluorescence signal FLS representing intensity of the fluorescence FL. The fluorescence signal FLS is output from the detector 960 to the signal processor 980.

The polarization controller 970 generates polarization modulation signals PMS. The polarization modulation signals PMS are output from the polarization controller 970 to the polarization modulator 920 and the signal processor 980. The polarization modulation signals PMS may have a signal waveform such as a sine wave, triangular wave or square wave shape.

The polarization modulator 920 modulates a polarization direction of the excitation light PL in response to the polarization modulation signal PMS. The signal processor 980 subjects the fluorescence signal FLS to synchronous detection with the polarization modulation signal PMS. For example, a lock-in amplifier may be used as the signal processor 980. In this case, the polarization modulation signal PMS is used as a reference signal of the lock-in amplifier. The fluorescence signal FLS is used as an input signal to the lock-in amplifier. Accordingly, signal components in synchronization with the polarization direction modulation are selectively extracted from the fluorescence signal FLS.

If the polarization modulator 920 modulates a polarization direction of the excitation light PL at a frequency fin response to the polarization modulation signal PMS, the fluorescence signal FLS includes a signal component Lf varying at the frequency f and a signal component Ls which does not vary at the frequency f. The signal processor 980 selectively extracts the signal component Lf. The signal processor 980 may remove the signal component Ls. Therefore, the detecting apparatus 900 may measure intensity of the fluorescence FL without being affected by unnecessary light irrelevant to the modulation of the polarization direction. An amount of detection target substances contained in a specimen is calculated from the intensity of the fluorescence FL.

The unnecessary light may include a component synchronizing with the modulation of the polarization direction. If transmittance of the prism 930 depends on the polarization direction of the excitation light PL, autofluorescence caused in the prism 930 also synchronizes with the polarization direction modulation of the excitation light PL. Therefore, the signal processor 980 may not appropriately remove signal components deriving from the autofluorescence caused in the prism 930.

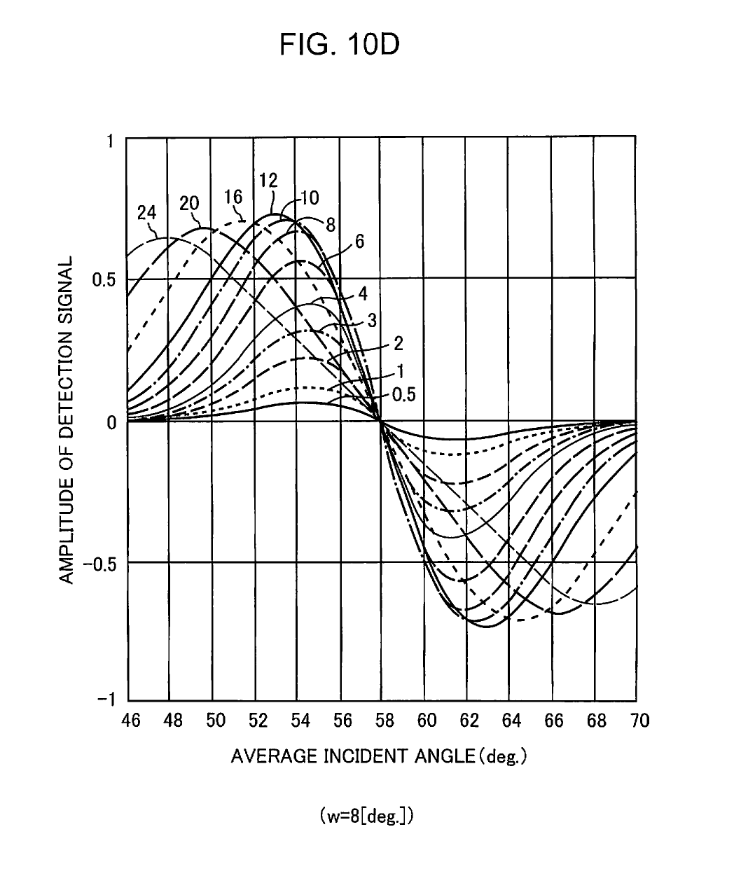

FIG. 16 is a graph showing characteristics of a detection signal generated by the signal processor 980. The problems of the conventional techniques are further described with reference to FIGS. 15 and 16.

The abscissa of the graph in FIG. 16 represents an incident angle of the excitation light PL on the metal thin film 940. The ordinate of the graph in FIG. 16 represents amplitude of the detection signal.

In the graph of FIG. 16, the resonance angle is represented by the sign “θᵣₑₛ”. When the incident angle is coincident with the resonance angle θᵣₑₛ, the detection signal is at a peak. Orientations of the prism 930, the metal thin film 940, the specimen cell 950 and the detector 960 are set so that the incident angle coincides with the resonance angle θᵣₑₛ. Accordingly, a large detection signal is obtained.

The detection signal shown in FIG. 16 includes an offset component P_{off}. The offset component P_{off} is caused by the unnecessary light in synchronization with the modulation of the polarization direction. Therefore, the detection signal may not accurately represent an amount of detection target substances in a specimen.

### First Embodiment

The inventors have developed techniques for generating detection signals from which the offset component is removed. A detecting apparatus configured to generate detection signals which may accurately represent an amount of detection target substances in a specimen is described in the first embodiment.

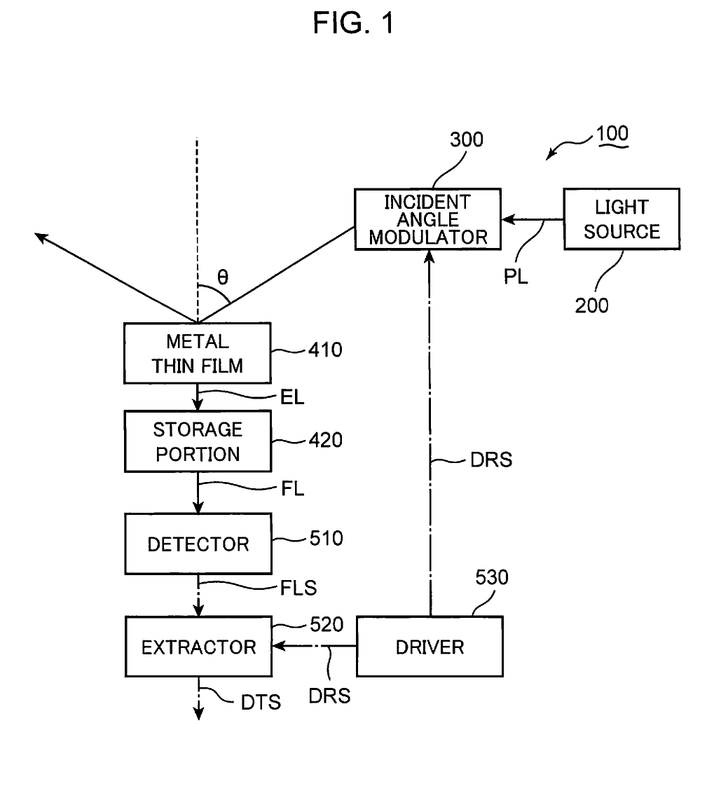

FIG. 1 is a schematic block diagram of the detecting apparatus 100 according to the first embodiment. The detecting apparatus 100 is described with reference to FIG. 1.

The detecting apparatus 100 includes a light source 200, an incident angle modulator 300, a metal thin film 410, a storage portion 420, a detector 510, an extractor 520 and a driver 530. The light source 200 emits excitation light PL toward the incident angle modulator 300. The excitation light PL may be a laser beam. Various kinds of light to cause evanescent light EL from the metal thin film 410 may be used as the excitation light PL. Principles of the present embodiment are not limited to a specific type of the light source 200.

The driver 530 generates driving signals DRS. The driving signals DRS are output from the driver 530 to the incident angle modulator 300 and the extractor 520. The driving signals DRS may have a signal waveform such as a sine wave, triangular wave or square wave shape. Alternatively, the driving signals DRS may be a pulse signal. The principles of the present embodiment are not limited to a specific signal waveform of the driving signals DRS.

The incident angle modulator 300 is driven by the driving signal DRS to change an incident angle θ of the excitation light PL on the metal thin film 410. Therefore, the incident angle θ changes in response to a change of the driving signal DRS. In this embodiment, the modulator is exemplified by the incident angle modulator 300.

The incident angle modulator 300 may include a reflecting member (not shown), which reflects the excitation light PL, a lens portion (not shown), which refracts the excitation light PL and other various optical elements. The reflecting member may be one galvanometer mirror. Alternatively, the reflecting member may be a plurality of galvanometer mirrors. Further alternatively, the reflecting member may be a polygon mirror, an acoustooptical modulator, an electrooptical modulator and other optical elements configured to change an optical path of the excitation light PL in response to electric signals. The lens portion may include one lens element. Alternatively, the lens portion may include a plurality of lens elements. The principles of the present embodiment are not limited to a specific structure of the incident angle modulator 300.

The excitation light PL enters the metal thin film 410 at the incident angle θ which is modulated by the incident angle modulator 300. The metal thin film 410 generates evanescent light EL under irradiation of the excitation light PL. The metal thin film 410 may be formed from various kinds of metal (e.g. Au, Ag, an Ag alloy and Al) which may cause the evanescent light EL. The metal thin film 410 is formed at a thickness to cause the evanescent light EL. The metal thin film 410 may have a laminated structure (e.g. a laminated thin film of Au and Cr or a laminated thin film of Au and Ti). The principles of the present embodiment are not limited to a specific material, a specific dimension and a specific structure of the metal thin film 410. In this embodiment, the metal film is exemplified by the metal thin film 410.

A specimen (not shown) is stored in the storage portion 420, the specimen containing detection target substances (not shown). The detection target substances may be fluorescent-labeled by fluorescent substances. The storage portion 420 is formed from a material transparent for fluorescence generated from the detection target substances. The storage portion 420 may be a general specimen cell used for fluorescence detection by the SPFS method. The principles of the present embodiment are not limited to a specific material and a specific structure of the storage portion 420.

The specimen may be various substances which may emit the fluorescence FL under irradiation of the evanescent light EL. For example, the specimen may be solution containing DNA subjected to fluorescent label processes. In this case, the detection target substances may be DNA. Alternatively, the detection target substances may be protein such as biomarkers or chemical substances. Various substances, which may be disposed near a surface of the metal thin film 410 and emit the fluorescence FL under the irradiation of the excitation light PL, may be used as the detection target substances. The principles of the present embodiment are not limited to specific types of the specimen and the detection target substances.

A user using the detecting apparatus 100 to measure an amount of the detection target substances may use various techniques to dispose the detection target substances near a surface of the metal thin film 410. Binding techniques such as binding of biotin and streptavidin, hybridization of DNA and an antigen-antibody reaction of protein may be suitably used for disposition of the detection target substances near a surface of the metal thin film 410. Alternatively, the detection target substances may float near a surface of the metal thin film 410. The principles of the present embodiment are not limited to a specific technique for disposing the detection target substances near a surface of the metal thin film 410.

The detection target substances may exist in liquid. Alternatively, the detection target substances may exist in gas. Therefore, the principles of the present embodiment are not limited to a specific presence state of the detection target substances.

The fluorescence FL generated from the specimen under the irradiation of the evanescent light EL propagates to the detector 510. The detector 510 generates a fluorescence signal FLS in correspondence to intensity of the fluorescence FL. If the fluorescence FL is intense, the fluorescence signal FLS may indicate a large value. If the fluorescence FL is weak, the fluorescence signal FLS may indicate a small value. The fluorescence signal FLS is output from the detector 510 to the extractor 520. The detector 510 may be a general photomultiplier used for fluorescence detection by the SPFS method. The principles of the present embodiment are not limited to a specific device used as the detector 510.

The extractor 520 receives the fluorescence signal FLS from the detector 510 and the driving signal DRS from the driver 530. The extractor 520 extracts synchronous signal components from the fluorescence signal FLS as signal components deriving from the specimen, the synchronous signal components changing in synchronization with a change of the driving signal DRS. Unlike the aforementioned conventional techniques, the extractor 520 extracts signal components synchronizing with modulation of an incident angle. Therefore, unnecessary light resultant from optical characteristics of optical elements (e.g. transmittance of a prism) used in the detecting apparatus 100 becomes less influential to the extracted signal components. Accordingly, the detecting apparatus 100 may accurately detect the detection target substances.

### Second Embodiment

The detecting apparatus described in the context of the first embodiment may accurately detect detection target substances under various conditions. Exemplary control of the detecting apparatus is described in the second embodiment.

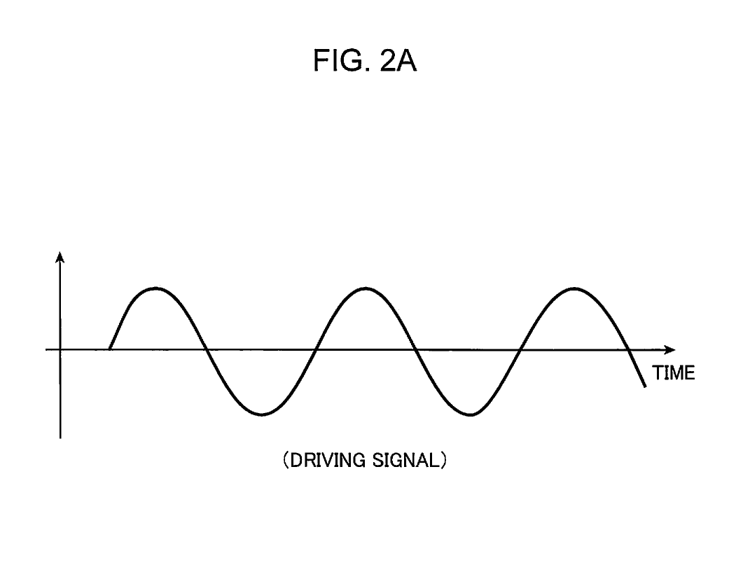

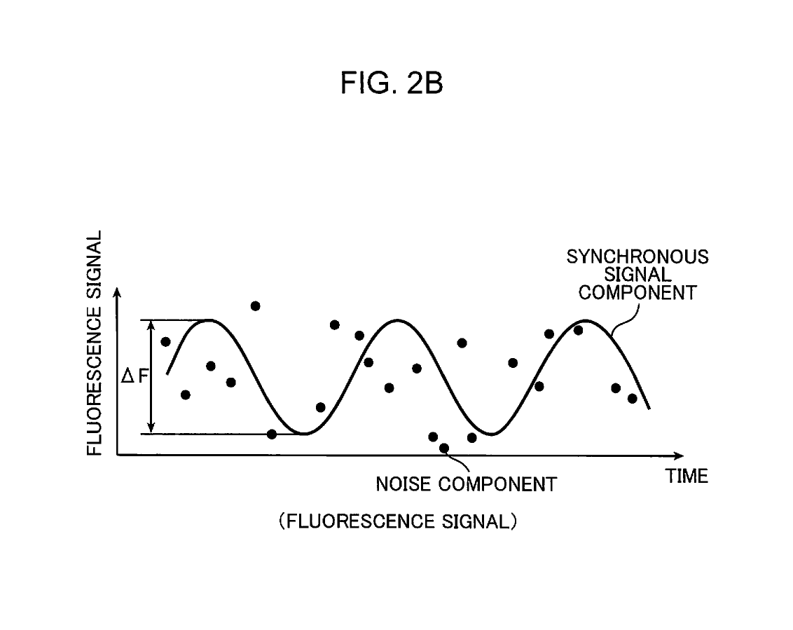

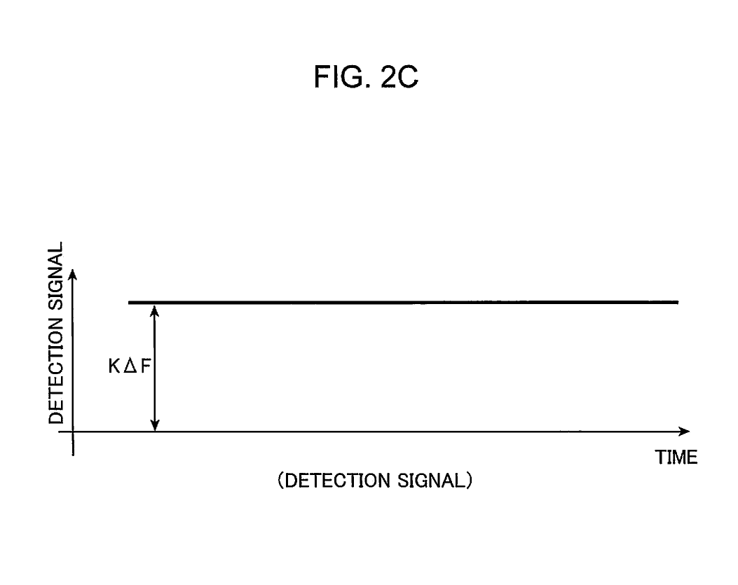

FIG. 2A is a schematic graph of the driving signal DRS. FIG. 2B is a graph conceptually showing the fluorescence signal FLS processed by the extractor 520. FIG. 2C is a schematic graph of a detection signal DTS output by the extractor 520. The exemplary control techniques of the detecting apparatus 100 are described with reference to FIGS. 1 to 2C.

As shown in FIG. 2A, the driving signal DRS may have a waveform of a sine wave shape. Since amplitude of the driving signal DRS is substantially consistent, a variation range of the incident angle θ is substantially consistent.

Intensity of the evanescent light EL also changes in response to the variation of the incident angle θ. Therefore, the intensity of the fluorescence FL emitted from the storage portion 420 also changes in response to the variation of the incident angle θ. The fluorescence FL emitted from the storage portion 420 may contain unnecessary light. Therefore, the detector 510 outputs the fluorescence signal FLS containing signal components deriving from the unnecessary light (hereinafter referred to as noise component).

The graph of FIG. 2B shows a signal component by a solid line, the signal component changing due to the variation of the incident angle θ. The graph of FIG. 2B conceptually shows noise components as dots. The extractor 520 refers to the driving signal DRS received from the driver 530 to extract the signal component (the solid line) from the fluorescence signal FLS as a synchronous signal component, the signal component (the solid line) changing at a frequency which is coincident with a variation frequency of the driving signal DRS. The extractor 520 extracts other signal components as noise components.

The graph of FIG. 2B shows amplitude of the synchronous signal component by the sign “ΔF”. The extractor 520 processes the synchronous signal component to calculate the amplitude ΔF of the synchronous signal component.

The extractor 520 multiplies the calculated amplitude ΔF with a predetermined amplitude coefficient K to generate the detection signal DTS. Therefore, the detection signal DTS may represent magnitude which is proportional to a change amount of the fluorescence signal FLS due to a change in the incident angle θ.

### Third Embodiment

A designer may design various detecting apparatuses on the basis of the design principles described in the context of the first embodiment. An exemplary detecting apparatus is described in the third embodiment.

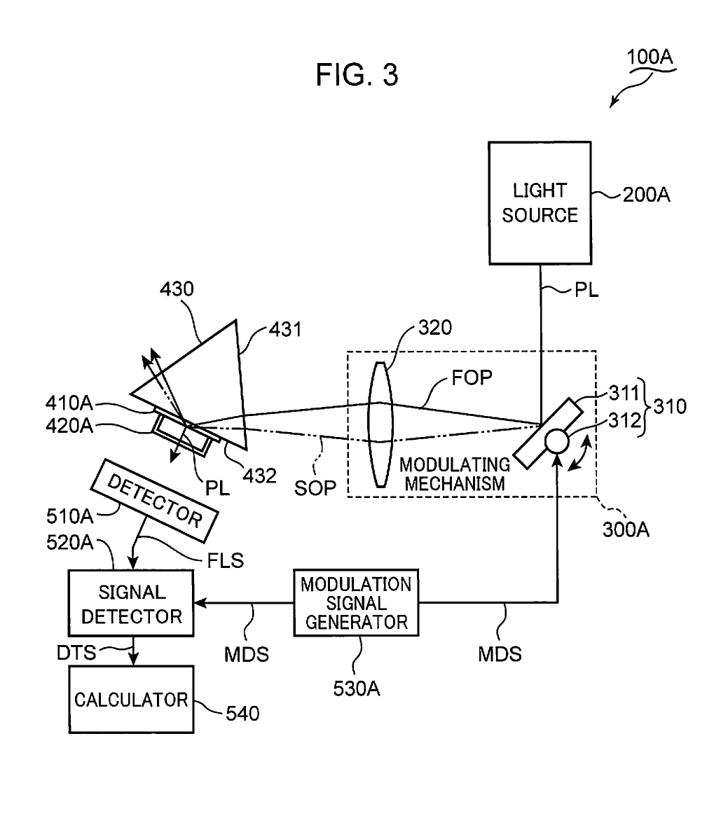

FIG. 3 is a schematic view of the detecting apparatus 100A according to the third embodiment. The detecting apparatus 100A is described with reference to FIGS. 1 and 3.

The detecting apparatus 100A includes a light source 200A, a modulating mechanism 300A, a metal thin film 410A, a specimen cell 420A, a detector 510A, a signal detector 520A and a modulation signal generator 530A. The light source 200A corresponds to the light source 200 described with reference to FIG. 1. The modulating mechanism 300A corresponds to the incident angle modulator 300 described with reference to FIG. 1. The metal thin film 410A corresponds to the metal thin film 410 described with reference to FIG. 1. The specimen cell 420A corresponds to the storage portion 420 described with reference to FIG. 1. The detector 510A corresponds to the detector 510 described with reference to FIG. 1. The signal detector 520A corresponds to the extractor 520 described with reference to FIG. 1.

The detecting apparatus 100A further includes a prism 430 and a calculator 540. Like the first embodiment, the light source 200A emits the excitation light PL. The prism 430 includes a first surface 431 and a second surface 432. The excitation light PL propagates through the modulating mechanism 300A, and then enters the first surface 431.

The metal thin film 410A may be formed on the second surface 432. Alternatively, the metal thin film 410A may be formed on a transparent member prepared separately from the prism 430. In this case, the transparent member is fixed to the second surface 432. Principles of the present embodiment are not limited to a specific formation technique for the metal thin film 410A.

The specimen cell 420A is fixed on the metal thin film 410A. The excitation light PL is refracted by the first surface 431, and then travels to the metal thin film 410A on the second surface 432. When the metal thin film 410A formed between the specimen cell 420A and the second surface 432 is irradiated by the excitation light PL, evanescent light is generated from the metal thin film 410A. Detection target substances disposed near the metal thin film 410A generate the fluorescence FL under the presence of the evanescent light.

The detector 510A receives the fluorescence FL. The detector 510A generates the fluorescence signal FLS representing intensity of the fluorescence FL. The fluorescence signal FLS is output from the detector 510A to the signal detector 520A.

The modulation signal generator 530A generates modulation signals MDS. The modulation signals MDS are output from the modulation signal generator 530A to the signal detector 520A and the modulating mechanism 300A. The modulation signals MDS correspond to the driving signals DRS described with reference to FIG. 1.

The signal detector 520A may refer to the modulation signal MDS to extract synchronous signal components from the fluorescence signal FLS on the basis of the control principles described in the context of the second embodiment. The signal detector 520A uses the synchronous signal components to generate the detection signal DTS. The detection signal DTS is output from the signal detector 520A to the calculator 540.

The calculator 540 calculates an amount of the detection target substances from the detection signal DTS. The calculator 540 may store reference data in advance, the reference data representing a relationship between amplitude of the detection signal DTS and an amount of the detection target substances. The calculator 540 may use the detection signal DTS and the reference data to output an amount of the detection target substances. The principles of the present embodiment are not limited to a specific calculation process executed by the calculator 540. Various calculation techniques which use the detection signal DTS may be utilized for the calculation of an amount of the detection target substances.

The calculator 540 may be a general computer device. The principles of the present embodiment are not limited to a specific device used as the calculator 540.

The modulating mechanism 300A includes a galvanometer mirror 310 and a lens 320. The light source 200A emits the excitation light PL to the galvanometer mirror 310. The galvanometer mirror 310 reflects the excitation light PL to the lens 320. The excitation light PL passes through the lens 320, and then enters the first surface 431 of the prism 430. In this embodiment, the reflector is exemplified by the galvanometer mirror 310. The lens portion is exemplified by the lens 320.

The galvanometer mirror 310 includes a reflective mirror 311 and a driving motor 312. The modulation signal MDS is output from the modulation signal generator 530A to the driving motor 312. The driving motor 312 causes a bidirectional rotary motion of the reflective mirror 311 in response to the modulation signal MDS. The excitation light PL enters the reflective mirror 311. A reflection direction of the excitation light PL is changed by the bidirectional rotary motion of the reflective mirror 311. Therefore, the modulating mechanism 300A may define a first optical path FOP and a second optical path SOP. An optical path of the excitation light PL changes between the first and second optical paths FOP, SOP.

The lens 320 refracts the excitation light PL. Accordingly, the excitation light PL positionally changing between the first and second optical paths FOP, SOP may propagate to a predetermined position on the metal thin film 410A. The second optical path SOP gets away from the first optical path FOP as the excitation light PL approaches the lens 320 from the galvanometer mirror 310. On the other hand, the second optical path SOP gets closer to the first optical path FOP as the excitation light PL approaches the metal thin film 410A from the lens 320. Accordingly, the second optical path SOP is coincident with the first optical path FOP on the metal thin film 410A. A designer designing the detecting apparatus 100A determines optical parameters such as a refractive index of the lens 320, a positional relationship between the lens 320 and the galvanometer mirror 310 and a rotational angle of the reflective mirror 311 so that the excitation light PL positionally stabilizes on the metal thin film 410A.

Since the optical path of the excitation light PL changes between the first and second optical paths FOP, SOP, an incident angle of the excitation light PL on the metal thin film 410A also changes. Accordingly, intensity of the fluorescence FL emitted from a specimen stored in the specimen cell 420A changes in synchronization with the change in the incident angle. The detector 510A receives the fluorescence FL to generate the fluorescence signal FLS representing the intensity of the fluorescence FL.

As described above, the modulation signals MDS are output to not only the driving motor 312 but also the signal detector 520A. Therefore, the signal detector 520A may refer to the modulation signal MDS to extract signal components from the fluorescence signal FLS, which is output from the detector 510A, the signal components changing in synchronization with the change in the incident angle of the excitation light PL. The signal detector 520A generates the detection signal DTS representing amplitude of the signal components which change in synchronization with the change in the incident angle of the excitation light PL. The detection signal DTS is output to the calculator 540. Conversion techniques from the fluorescence signal FLS into the detection signal DTS may depend on the principles of the second embodiment.

### Fourth Embodiment

The detecting apparatus described in the context of the third embodiment may operate under various optical settings. A user using the detecting apparatus may determine the optical settings of the detecting apparatus so that the signal detector outputs a detection signal having a large value. If the detection signal has a large value, the calculator may accurately calculate an amount of the detection target substances. Exemplary optical settings of the detecting apparatus are described in the fourth embodiment.

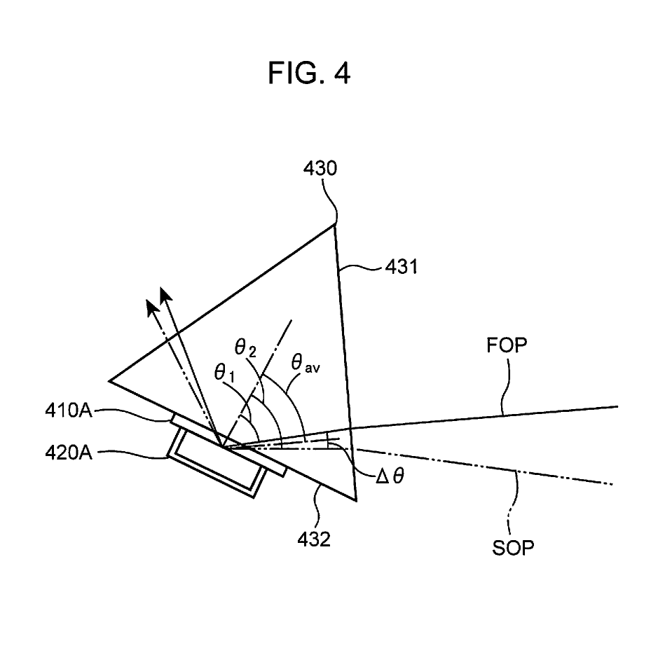

FIG. 4 is a schematic enlarged view of the detecting apparatus 100A around the prism 430. The optical settings of the detecting apparatus 100A are described with reference to FIGS. 3 and 4.

FIG. 4 shows a first incident angle θ₁ (θ₁>0) and a second incident angle θ₂ (θ₂>0). The excitation light PL propagating along the first optical path FOP enters the metal thin film 410A at the first incident angle θ₁. The excitation light PL propagating along the second optical path SOP enters the metal thin film 410A at the second incident angle θ₂. The second incident angle θ₂ is set to a value different from the first incident angle θ₁. In FIG. 4, the second incident angle θ₂ is larger than the first incident angle θ₁ is. Alternatively, the second incident angle θ₂ may be smaller than the first incident angle θ₁ is. Principles of the present embodiment are not limited at all by a size relationship between the first and second incident angles θ₁, θ₂.

FIG. 4 shows modulation amplitude Δθ of an incident angle. As described in the context of the third embodiment, the modulation amplitude Δθ is defined by a rotational angle of the galvanometer mirror 310. The modulation amplitude Δθ may be represented by the following formula.

[Math 1]

Δθ=|θ₂−θ₁|

FIG. 4 shows an average incident angle θₐᵥ of the excitation light PL on the metal thin film 410A. The average incident angle θₐᵥ may be considered as a reference incident angle when the modulation amplitude Δθ is set to “0”. The average incident angle θₐᵥ may be represented by the following formula.

$${θ}_{av} = \frac{{θ}_{1} + {θ}_{2}}{2} \qquad [ Math 2 ]$$

The fluorescence FL from the detection target substances is generated by the surface plasmon resonance. Intensity of the fluorescence FL rapidly increases near the resonance angle. Therefore, if a user sets the average incident angle θₐᵥ near the resonance angle, intensity of the fluorescence FL from the detection target substances sensitively changes in response to the modulation of the incident angle. In this case, the detection signal DTS may have a large value.

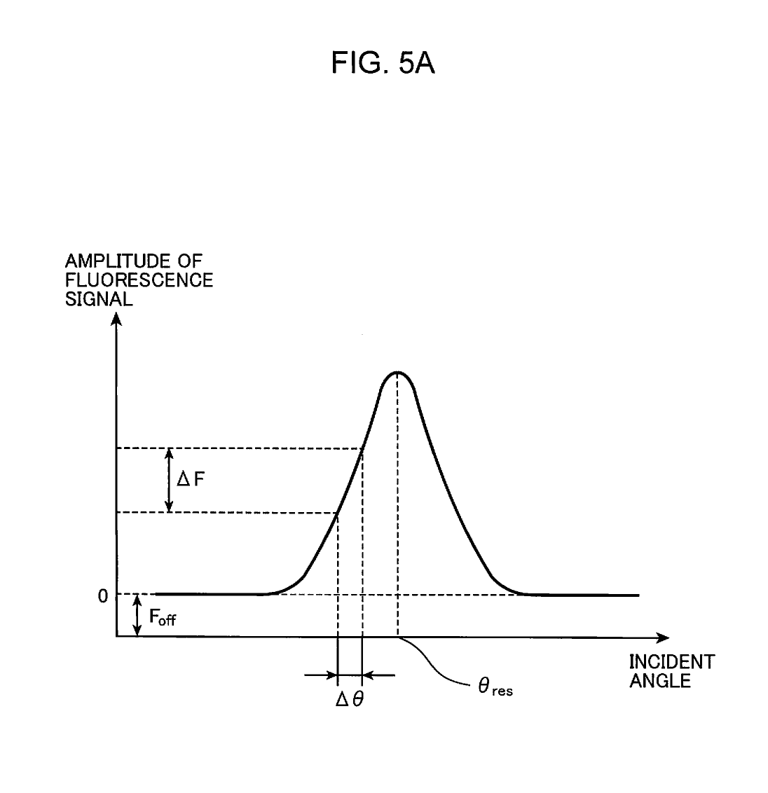

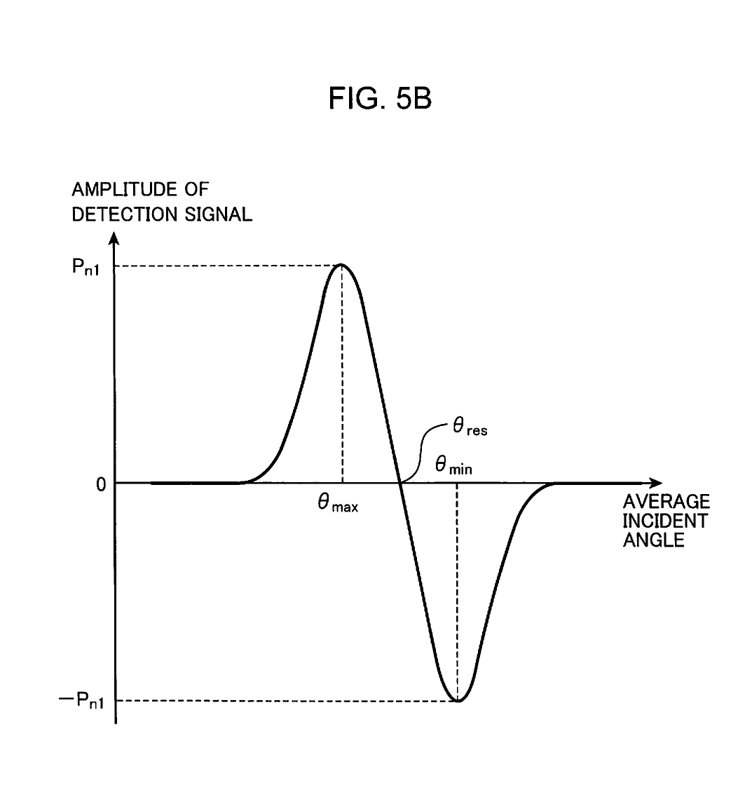

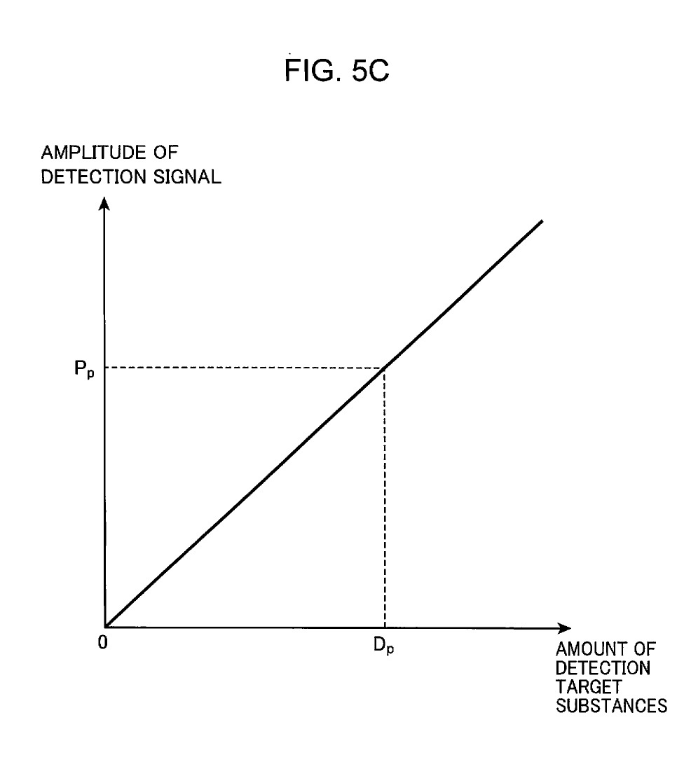

FIG. 5A is a graph schematically showing a relationship between an incident angle and amplitude of the fluorescence signal FLS. The optical settings of the detecting apparatus 100A are further described with reference to FIGS. 3 to 5A.

The abscissa of the graph in FIG. 5A indicates the incident angle. The ordinate of the graph in FIG. 5A indicates the amplitude of the fluorescence signal FLS. A user using the detecting apparatus 100A may stop the modulating mechanism 300A whereas the user may integrally rotate the metal thin film 410A, the specimen cell 420A, the prism 430 and the detector 510A to change an incident angle on the metal thin film 410A. Consequently, the user may obtain the graph shown in FIG. 5A.

From the graph of FIG. 5A, the user may identify an incident angle at which the fluorescence signal FLS is at a peak. The incident angle at which the fluorescence signal FLS is at a peak is the resonance angle θᵣₑₛ.

It is figured out from the graph of FIG. 5A that the fluorescence signal FLS includes a signal component F_{off} irrelevant to a change in the incident angle. The detecting apparatus 100A may use the synchronous detection techniques between the fluorescence signal FLS and the modulation signal MDS to appropriately remove the signal component F_{off}.

In the graph of FIG. 5A, the user may set a variation range of the incident angle in which there is a high change ratio of the fluorescence signal FLS in the incident angle range. The amplitude of the fluorescence signal FLS changes by “ΔF” as shown in FIG. 5A when the incident angle changes by the modulation amplitude Δθ in the appropriately set variation range. The signal detector 520A may uses the synchronous detection techniques between the fluorescence signal FLS and the modulation signal MDS to selectively extract signal components from the fluorescence signal FLS, the signal components changing by “ΔF”. The user may set the modulation amplitude Δθ so as to cause the change “ΔF” of the signal components and obtain sufficient detection accuracy about an amount of measurement target substances.

FIG. 5B is a graph schematically showing a relationship between the average incident angle θₐᵥ and the detection signal DTS. The optical settings of the detecting apparatus 100A are further described with reference to FIGS. 3 to 5B.

The abscissa of the graph in FIG. 5B indicates the average incident angle θₐᵥ. The ordinate of the graph in FIG. 5B indicates amplitude of the detection signal DTS. A user using the detecting apparatus 100A may set the modulation amplitude Δθ to a predetermined value and actuate the modulating mechanism 300A. Meanwhile, the user may integrally rotate the metal thin film 410A, the specimen cell 420A, the prism 430 and the detector 510A to change a value of the average incident angle θₐᵥ. Accordingly, there is a change in the average incident angle θₐᵥ on the metal thin film 410A. Therefore, the user may obtain the graph shown in FIG. 5B.

As described in the context of the second embodiment, the amplitude of the detection signal DTS is substantially proportional to “ΔF” described with reference to FIG. 5A. When the average incident angle θₐᵥ is set to a value largely different from the resonance angle θᵣₑₛ or when the average incident angle θₐᵥ coincides with the resonance angle θᵣₑₛ, a value of the detection signal DTS is “0”.

In FIG. 5B, the average incident angle at which there is a maximized value of the detection signal DTS is indicated by the sign “θₘₐₓ”. In FIG. 5B, the average incident angle at which there is a minimized value of the detection signal DTS is indicated by the sign “θₘᵢₙ”. It is figured out from the graph of FIG. 5B that if the average incident angle θₐᵥ is set to “θₘₐₓ” or “θₘᵢₙ”, the absolute value of the detection signal DTS is maximized (i.e. the value of the detection signal gets closer to the peak value as the incident angle gets closer to the average incident angle θₐᵥ). This means that if the average incident angle θₐᵥ is set to “θₘₐₓ” or “θₘᵢₙ”, there is maximized sensitivity of the detection signal DTS to a change in intensity of the fluorescence FL. Therefore, the user may set the average incident angle θₐᵥ to “θₘₐₓ” or “θₘᵢₙ”.

In FIG. 5B, the amplitude of the detection signal DTS when the average incident angle θₐᵥ is set to “θₘₐₓ” or “θₘᵢₙ” is indicated by “±Pₙ₁”. As described in the context of the second embodiment, the amplitude (absolute value) of the detection signal DTS is proportional to intensity of the fluorescence FL. Therefore, the calculator 540 may determine an amount of detection target substances as a value proportional to the detection signal DTS. As described above, the synchronous detection techniques between the fluorescence signal FLS and the modulation signal MDS remove the signal component F_{off} described with reference to FIG. 5A. Therefore, the signal component F_{off} does not affect the amplitude “±Pₙ₁” of the detection signal DTS. Accordingly, the detecting apparatus 100A may accurately determine an amount of the detection target substances.

FIG. 5C is a graph showing calibration curve data stored by the calculator 540. Techniques for calculating an amount of the detection target substances are described with reference to FIGS. 3 to 5C. The phrase “an amount of the detection target substances” may mean concentration of the detection target substances in the specimen. Alternatively, the phrase “an amount of the detection target substances” may mean the number of detection target substances in the specimen. The principles of the present embodiment are not limited to a specific definition of “an amount of the detection target substances”.

A user prepares a specimen containing a known amount of detection target substances. The user then stores the prepared specimen in the specimen cell 420A. Thereafter, the user makes the excitation light PL incident on the metal thin film 41 OA under the optical conditions of the average incident angle θₐᵥ and the modulation amplitude Δθ described with reference to FIGS. 5A and 5B. Accordingly, the signal detector 520A may generate the detection signal DTS. Consequently, the user may find amplitude of the detection signal DTS in correspondence to an amount of the detection target substances.

The user prepares specimens different in an amount of the detection target substances to examine amplitude of the detection signal DTS for each of the specimens. Consequently, the calibration curve shown in FIG. 5C is obtained. The calculator 540 may store data of the obtained calibration curve as a mathematical function. Alternatively, the calculator 540 may store the data of the obtained calibration curve as a lookup table. The principles of the present embodiment are not limited to a specific storage form of the calibration curve data.

The user then stores a specimen containing an unknown amount of the detection target substances in the specimen cell 420A. If amplitude of the detection signal DTS is “Pₚ”, the calculator 540 may refer to the calibration curve data to calculate an amount “Dₚ” of the detection target substances in correspondence to the amplitude “Pₚ” of the detection signal DTS.

The calibration curve shown in FIG. 5C indicates a proportional relationship between amplitude of the detection signal DTS and an amount of the detection target substances. However, the amplitude of the detection signal DTS does not have to be proportional to an amount of the detection target substances. For example, amplitude of the detection signal DTS may not be proportional to an amount of the detection target substances because of saturation characteristics of the detector 510A. Even in this case, the calculator 540 may accurately determine an amount of the detection target substances on the basis of the aforementioned creation techniques for the calibration curve data. Therefore, the principles of the present embodiment are not limited to specific calibration curve data.

### Fifth Embodiment

The detecting apparatus described in the context of the third embodiment uses a single lens element to adjust an optical path. Alternatively, the detecting apparatus may include a plurality of lens elements. If the lens elements are used, each of the lens elements does not have to have an excessively high refractive index. A detecting apparatus including a plurality of lens elements is described in the fifth embodiment.

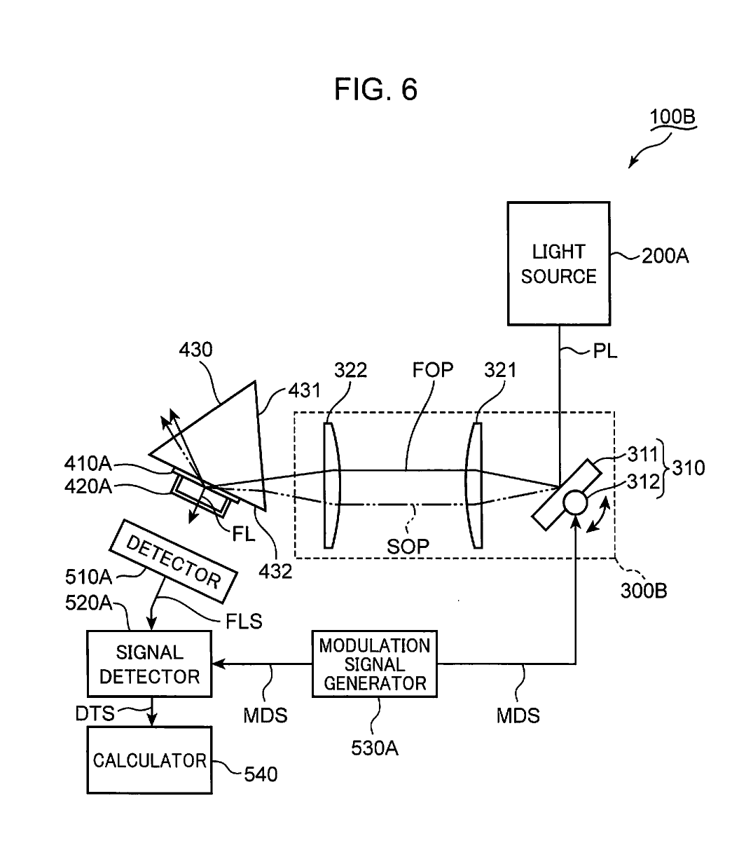

FIG. 6 is a schematic view of the detecting apparatus 100B according to the fifth embodiment. The detecting apparatus 100B is described with reference to FIGS. 1 and 6. Reference numerals and signs used in common between the third and fifth embodiments mean that elements denoted by the common reference numerals and signs have the same functions as the third embodiment. Therefore, the description of the third embodiment is applicable to these elements.

Like the third embodiment, the detecting apparatus 100B includes the light source 200A, the metal thin film 410A, the specimen cell 420A, the prism 430, the detector 510A, the signal detector 520A, the modulation signal generator 530A and the calculator 540. The description of the third embodiment is applied to these elements.

The detecting apparatus 100B further includes a modulating mechanism 300B. The modulating mechanism 300B corresponds to the incident angle modulator 300 described with reference to FIG. 1.

Like the third embodiment, the modulating mechanism 300B includes the galvanometer mirror 310. The description of the third embodiment is applied to the galvanometer mirror 310.

The modulating mechanism 300B further includes a first lens 321 and a second lens 322. The first lens 321 is situated between the galvanometer mirror 310 and the second lens 322. The second lens 322 is situated between the first lens 321 and the prism 430.

The light source 200A emits the excitation light PL to the galvanometer mirror 310. The galvanometer mirror 310 reflects the excitation light PL toward the first lens 321. The excitation light PL sequentially passes through the first and second lenses 321, 322, and then enters the first surface 431 of the prism 430.

Like the third embodiment, the galvanometer mirror 310 changes a reflection direction of the excitation light PL in response to the modulation signal MDS. Therefore, the modulating mechanism 300B may define the first and second optical paths FOP, SOP. An optical path of the excitation light PL positionally changes between the first and second optical paths FOP, SOP.

The second optical path SOP is substantially parallel to the first optical path FOP in a propagation section from the first lens 321 to the second lens 322. Therefore, an angular difference between the first and second optical paths FOP, SOP is smaller in the propagation section from the first lens 321 to the second lens 322 than a propagation section from the galvanometer mirror 310 to the first lens 321. The angular difference between the first and second optical paths FOP, SOP is smaller in the propagation section from the first lens 321 to the second lens 322 than a propagation section from the second lens 322 to the prism 430. Therefore, the first and second lenses 321, 322 do not have to have an excessively high refractive index. Like the third embodiment, a designer designing the detecting apparatus 100B determines optical parameters such as refractive indexes of the first and second lenses 321, 322, a positional relationship among the first and second lenses 321, 322 and the galvanometer mirror 310, and a rotational angle of the reflective mirror 311 so that the second optical path SOP coincides with the first optical path FOP on the metal thin film 410A.

Since the optical path of the excitation light PL changes between the first and second optical paths FOP, SOP, an incident angle of the excitation light PL on the metal thin film 410A also changes. Accordingly, intensity of the fluorescence FL emitted from the specimen stored in the specimen cell 420A changes in synchronization with the change in the incident angle. The detector 510A receives the fluorescence FL to generate the fluorescence signal FLS representing the intensity of the fluorescence FL.

Like the third embodiment, the modulation signals MDS are output to not only the driving motor 312 but also the signal detector 520A. Therefore, the signal detector 520A may refer to the modulation signal MDS to extract signal components from the fluorescence signal FLS of the detector 510A, the signal components changing in synchronization with the change in the incident angle of the excitation light PL. The signal detector 520A generates the detection signal DTS representing amplitude of the signal component, which changes in synchronization with the change in the incident angle of the excitation light PL. The detection signal DTS is output to the calculator 540. Conversion techniques from the fluorescence signal FLS into the detection signal DTS may depend on the principles of the second and/or fourth embodiments. Techniques for determining an amount of detection target substances from the detection signal DTS may depend on the principle of the fourth embodiment.

### Sixth Embodiment

The detecting apparatus described in the context of the third embodiment uses a single lens element to adjust an optical path. Alternatively, a designer may design a detecting apparatus without a lens element. A detecting apparatus designed without a lens element is described in the sixth embodiment.

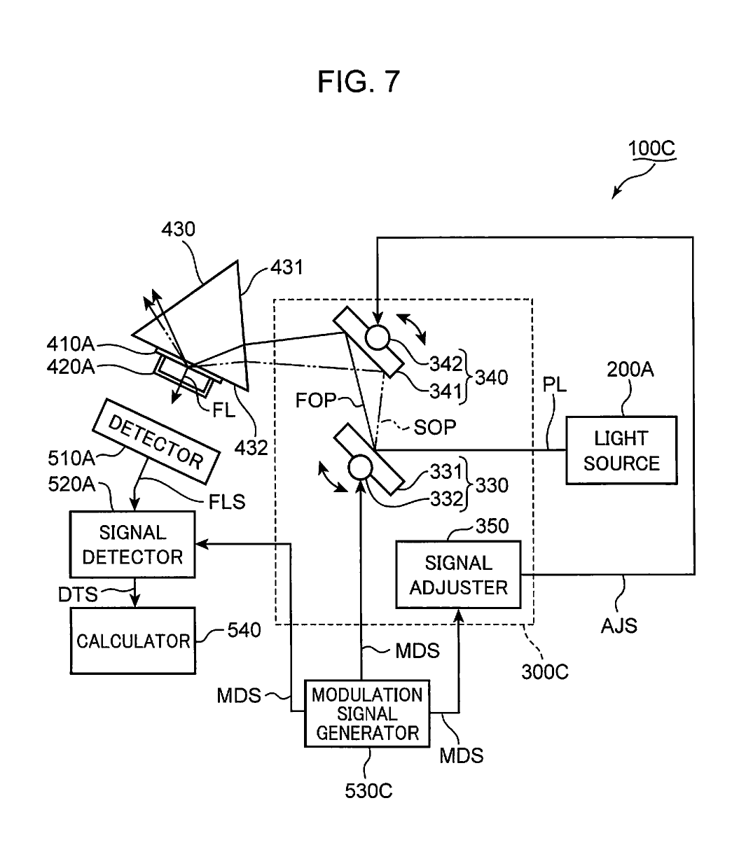

FIG. 7 is a schematic view of the detecting apparatus 100C according to the sixth embodiment. The detecting apparatus 100C is described with reference to FIGS. 1, 4 and 7. Reference numerals and signs used in common between the third and sixth embodiments mean that elements denoted by the common reference numerals and signs have the same functions as the third embodiment. Therefore, the description of the third embodiment is applicable to these elements.

Like the third embodiment, the detecting apparatus 100C includes the light source 200A, the metal thin film 410A, the specimen cell 420A, the prism 430, the detector 510A, the signal detector 520A and the calculator 540. The description of the third embodiment is applied to these elements.

The detecting apparatus 100C further includes a modulating mechanism 300C and a modulation signal generator 530C. The modulating mechanism 300C corresponds to the incident angle modulator 300 described with reference to FIG. 1. The modulation signal generator 530C corresponds to the driver 530 described with reference to FIG. 1.

The modulating mechanism 300C includes a first galvanometer mirror 330, a second galvanometer mirror 340 and a signal adjuster 350. The modulation signal generator 530C outputs the modulation signals MDS to the first galvanometer mirror 330, the signal adjuster 350 and the signal detector 520A.

The first galvanometer mirror 330 includes a reflective mirror 331 and a driving motor 332. The second galvanometer mirror 340 includes a reflective mirror 341 and a driving motor 342. The signal adjuster 350 adjusts amplitude and/or a phase of the modulation signal MDS to generate an adjustment signal AJS.

The modulation signal MDS is output from the modulation signal generator 530C to the driving motor 332 of the first galvanometer mirror 330. The driving motor 332 causes a bidirectional rotary motion of the reflective mirror 331 in response to the modulation signal MDS. The excitation light PL enters the reflective mirror 331 from the light source 200A. The reflective mirror 331 reflects the excitation light PL toward the second galvanometer mirror 340. In this embodiment, the first reflective mirror is exemplified by the first galvanometer mirror 330.

The adjustment signal AJS is output from the signal adjuster 350 to the driving motor 342 of the second galvanometer mirror 340. The driving motor 342 causes a bidirectional rotary motion of the reflective mirror 341 in response to the adjustment signal AJS. The excitation light PL reflected by the first galvanometer mirror 330 enters the reflective mirror 341 of the second galvanometer mirror 340. The reflective mirror 341 of the second galvanometer mirror 340 reflects the excitation light PL toward the first surface 431 of the prism 430. In this embodiment, the second reflective mirror is exemplified by the second galvanometer mirror 340.

A reflection direction of the excitation light PL is changed by the bidirectional rotary motions of the reflective mirrors 331, 341. Therefore, the modulating mechanism 300C may define the first and second optical paths FOP, SOP. When the incident angle of the excitation light PL on the metal thin film 410A is set to the first incident angle θ₁, the first and second galvanometer mirrors 330, 340 define the first optical path FOP in cooperation with each other. When the incident angle of the excitation light PL on the metal thin film 410A is set to the second incident angle θ₂, the first and second galvanometer mirrors 330, 340 define the second optical path SOP in cooperation with each other. An optical path of the excitation light PL positionally changes between the first and second optical paths FOP, SOP.

The second optical path SOP gets away from the first optical path FOP as the excitation light PL approaches the second galvanometer mirror 340 from the first galvanometer mirror 330. The second optical path SOP gets closer to the first optical path FOP as the excitation light PL approaches the metal thin film 410A from the second galvanometer mirror 340. Eventually, the second optical path SOP coincides with the first optical path FOP on the metal thin film 410A. The signal adjuster 350 adjusts amplitude and/or a phase of the modulation signal MDS so that an irradiation position of the excitation light PL is stabilized on the metal thin film 410A.

Since the optical path of the excitation light PL changes between the first and second optical paths FOP, SOP, the incident angle of the excitation light PL on the metal thin film 410A also changes between the first and second incident angles θ₁, θ₂. Accordingly, intensity of the fluorescence FL emitted from the specimen stored in the specimen cell 420A changes in synchronization with the change in the incident angle. The detector 510A receives the fluorescence FL to generate the fluorescence signal FLS representing the intensity of the fluorescence FL.

Like the third embodiment, the modulation signal MDS is output to the signal detector 520A. Therefore, the signal detector 520A may refer to the modulation signal MDS to extract signal components from the fluorescence signal FLS of the detector 510A, the signal components changing in synchronization with the change in the incident angle of the excitation light PL. The signal detector 520A generates the detection signal DTS representing amplitude of the signal components which change in synchronization with the change in the incident angle of the excitation light PL. The detection signal DTS is output to the calculator 540. Conversion techniques from the fluorescence signal FLS into the detection signal DTS may depend on the principles of the second and/or fourth embodiments. Techniques for determining an amount of detection target substances from the detection signal DTS may depend on the principles of the fourth embodiment.

### Seventh Embodiment

As described in the context of the fourth embodiment, the setting of a central value (i.e. the average incident angle) of the variation range of the incident angle greatly affects sensitivity in conversion processes from the fluorescence signal into the detection signal. Therefore, the detecting apparatus may include an element for adjusting the central value of a variation range of an incident angle. A detecting device configured to adjust the central value of the variation range of the incident angle is described in the seventh embodiment.

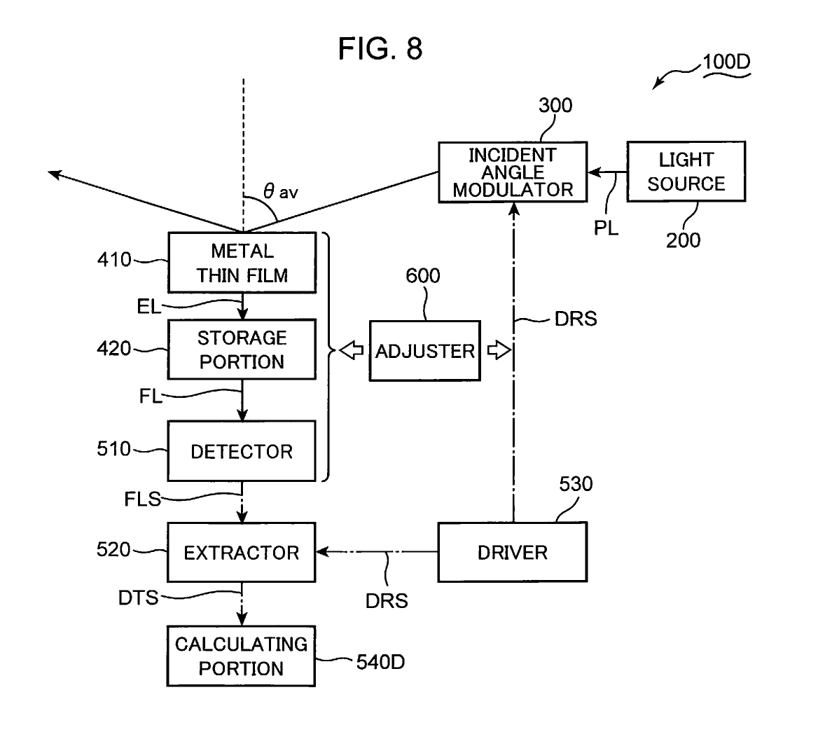

FIG. 8 is a schematic block diagram of the detecting apparatus 100D according to the seventh embodiment. The detecting apparatus 100D is described with reference to FIGS. 3, 5A, 5B and 8. Reference numerals and signs used in common among the first, second and seventh embodiments mean that elements denoted by the common reference numerals and signs have the same functions as the first and/or second embodiments. Therefore, the description of the first and/or second embodiments is applicable to these elements.

Like the first embodiment, the detecting apparatus 100D includes the light source 200, the incident angle modulator 300, the metal thin film 410, the storage portion 420, the detector 510, the extractor 520 and the driver 530. The description of the first embodiment is applied to these elements.

The detecting apparatus 100D further includes a calculating portion 540D and an adjuster 600. The calculating portion 540D corresponds to the calculator 540 described with reference to FIG. 3.

The adjuster 600 adjusts the average incident angle θₐᵥ of the excitation light PL made incident on the metal thin film 410. In this embodiment, the central value of the variation range of the incident angle is exemplified by the average incident angle θₐᵥ.

The adjuster 600 may integrally move the metal thin film 410, the storage portion 420 and the detector 510 to set the average angle θₐᵥ to an appropriate value. Alternatively, the adjuster 600 may use the driving signal DRS output from the driver 530 to the incident angle modulator 300 to set the average angle θₐᵥ to an appropriate value. Principles of the present embodiment are not limited to a specific technique for adjusting the average angle θₐᵥ.

The adjuster 600 may determine an appropriate value of the average angle θₐᵥ with reference to the fluorescence signal FLS output from the detector 510. As described with reference to FIG. 5A, the adjuster 600 may set an incident angle as the average angle θₐᵥ, if there is a high change ratio of amplitude of the fluorescence signal FLS at the incident angle. Alternatively, the adjuster 600 may determine an appropriate value of the average angle θₐᵥ with reference to the detection signal DTS output from the extractor 520. As described with reference to FIG. 5B, “θₘₐₓ” or “θₘᵢₙ” may be set as the average angle θₐᵥ. The principles of the present embodiment are not limited to specific feedback control for the adjuster 600.

### Eighth Embodiment

The average incident angle may be mechanically adjusted. A detecting apparatus configured to mechanically adjust the average incident angle is described in the eighth embodiment.

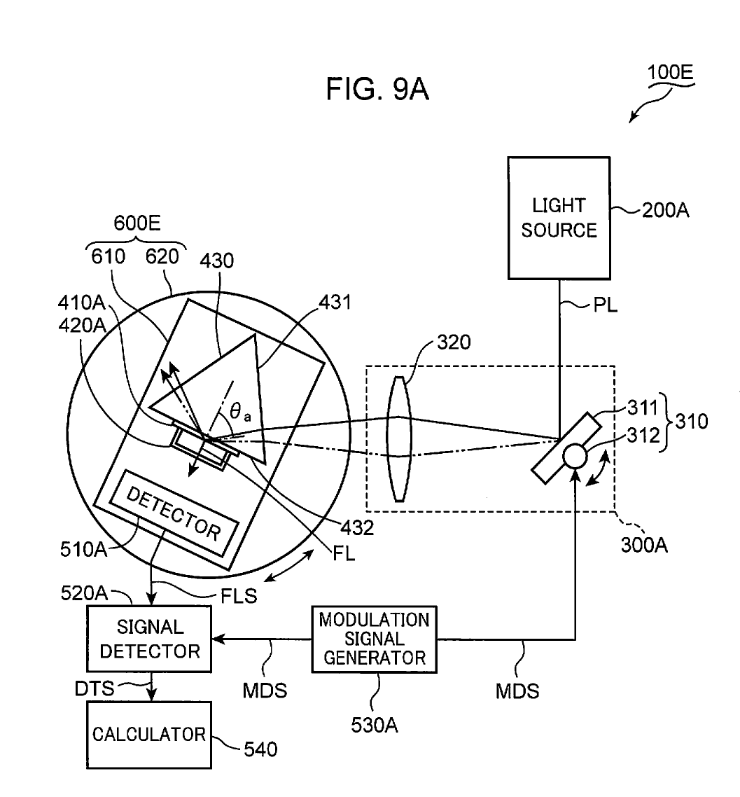

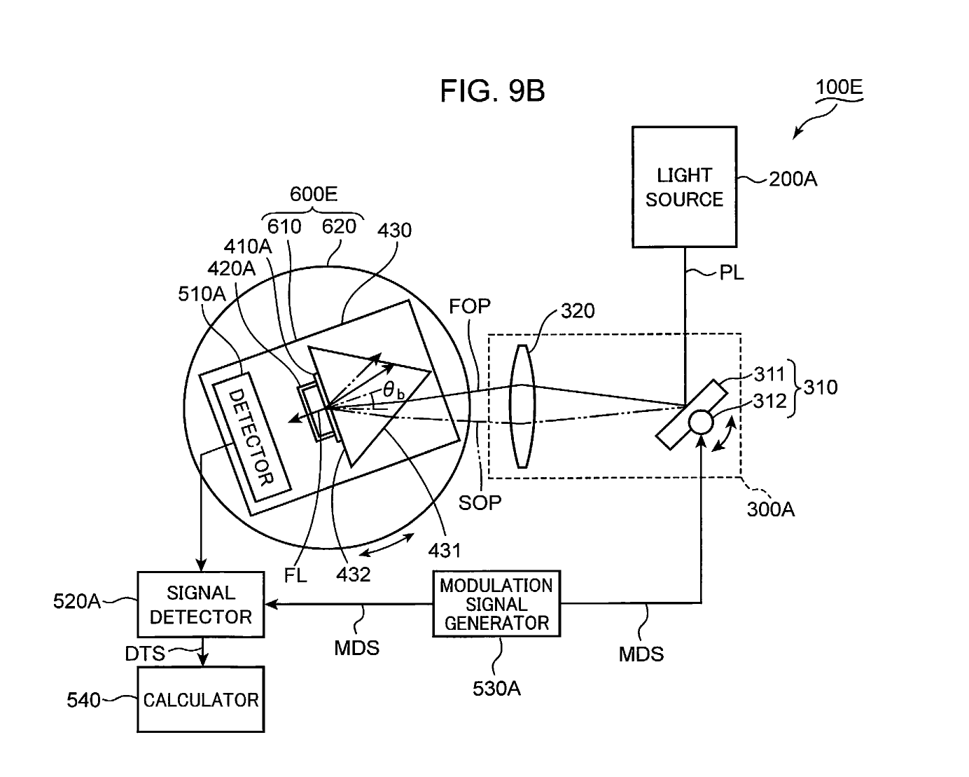

FIGS. 9A and 9B are schematic views of the detecting apparatus 100E according to the eighth embodiment. The detecting apparatus 100E is described with reference to FIGS. 5B, 8 to 9B. Reference numerals and signs used in common between the third and eighth embodiments mean that elements denoted by the common reference numerals and signs have the same functions as the third embodiment. Therefore, the description of the third embodiment is applicable to these elements.

Like the third embodiment, the detecting apparatus 100E includes the light source 200A, the modulating mechanism 300A, the metal thin film 410A, the specimen cell 420A, the prism 430, the detector 51 OA, the signal detector 520A, the modulation signal generator 530A and the calculator 540. The description of the third embodiment is applied to these elements.

The detecting apparatus 100E further includes an adjusting mechanism 600E. The adjusting mechanism 600E corresponds to the adjuster 600 described with reference to FIG. 8.

The adjusting mechanism 600E includes a holder plate 610 and a driving motor 620. The metal thin film 410A, the specimen cell 420A, the prism 430 and the detector 510A are fixed to the holder plate 610. The driving motor 620 rotates the holder plate 610. A rotational center of the holder plate 610 may be coincident with an intersection of the first and second optical paths FOP, SOP on the metal thin film 410A. In this embodiment, the holder is exemplified by the holder plate 610. The rotary portion is exemplified by the driving motor 620.

The detecting apparatus 100E shown in FIG. 9A sets the average incident angle θₐᵥ to an incident angle θₐ. The detecting apparatus 100E shown in FIG. 9B sets the average incident angle θₐᵥ to an incident angle θ_{b} smaller than the incident angle θₐ. The detecting apparatus 100E may use the adjusting mechanism 600E to easily change a value of the average incident angle θₐᵥ.

When detection target substances or contaminants adhere to the metal thin film 410A and/or when the detection target substances or the contaminants separate from the metal thin film 410A, there may be a change in the resonance angle θᵣₑₛ. If the resonate angle θᵣₑₛ changes while a user sets the average incident angle θₐᵥ to the incident angle θₐ to measure an amount of the detection target substances, the user may actuate the adjusting mechanism 600E to acquire data shown in FIG. 5B. If the incident angle θ_{b} is equivalent to “θₘₐₓ” or “θₘᵢₙ” shown in FIG. 5B, the user may set the incident angle θ_{b} as the average incident angle θₐᵥ again. The user may then continue the measurement of an amount of the detection target substances.

### Ninth Embodiment

The inventors used the detecting apparatus built on the basis of the design principles described in the context of the eighth embodiment to carry out various experiments and identify an appropriate range of modulation amplitude. The experiments carried out by the inventors are described in the ninth embodiment.

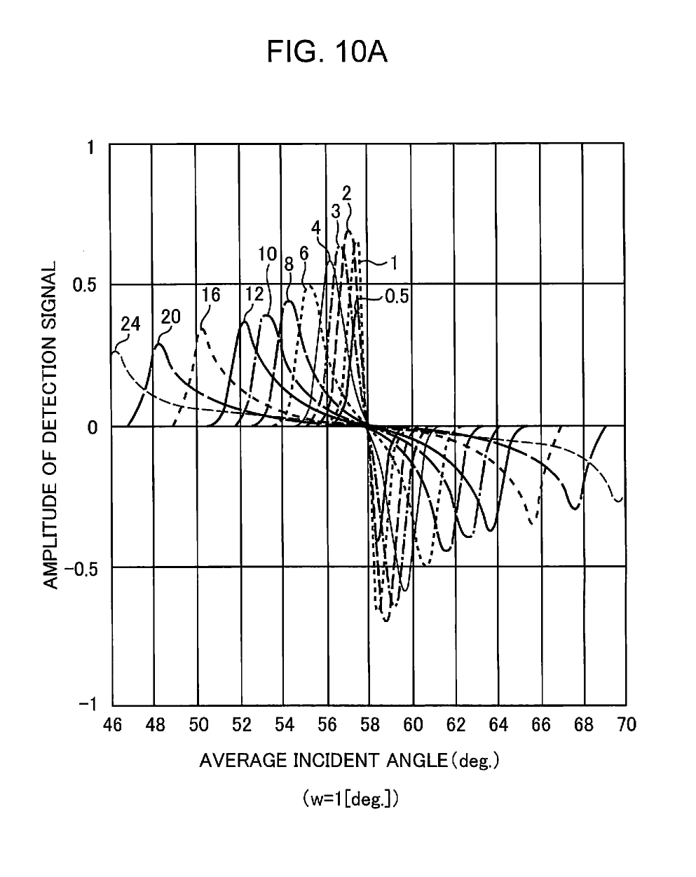

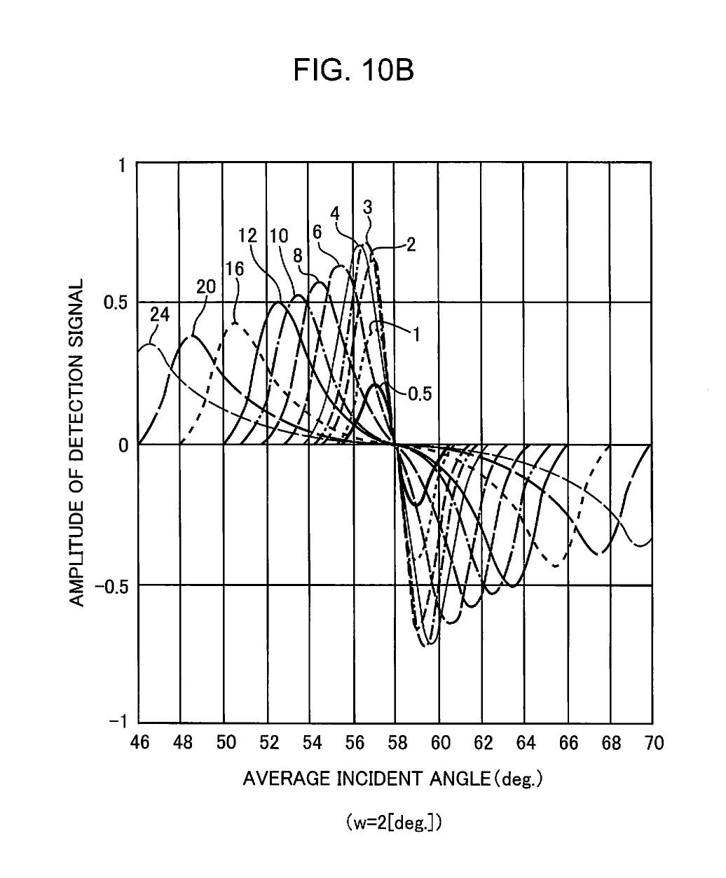

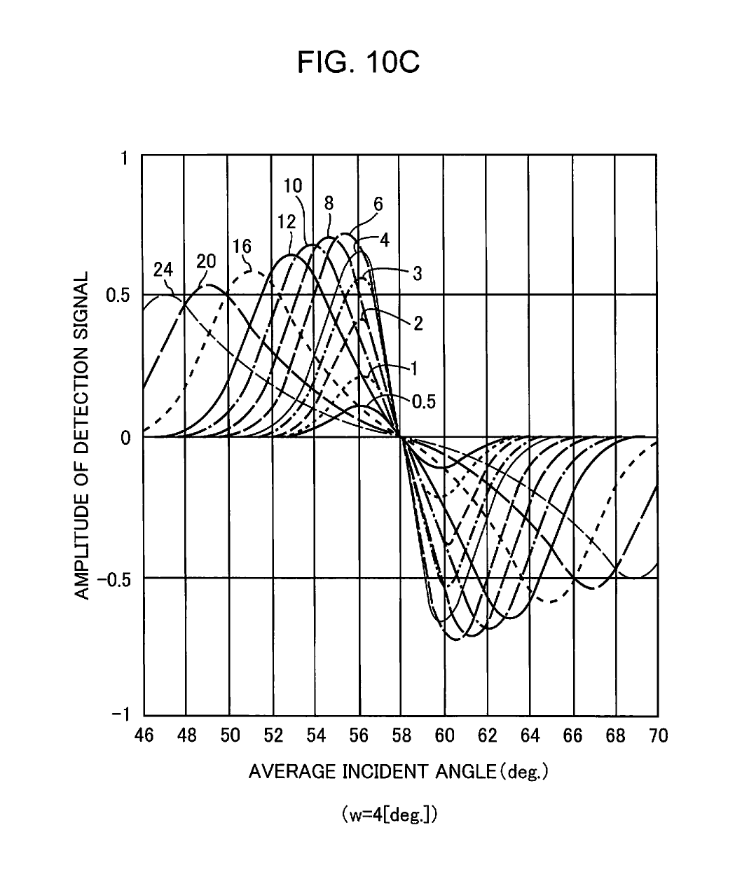

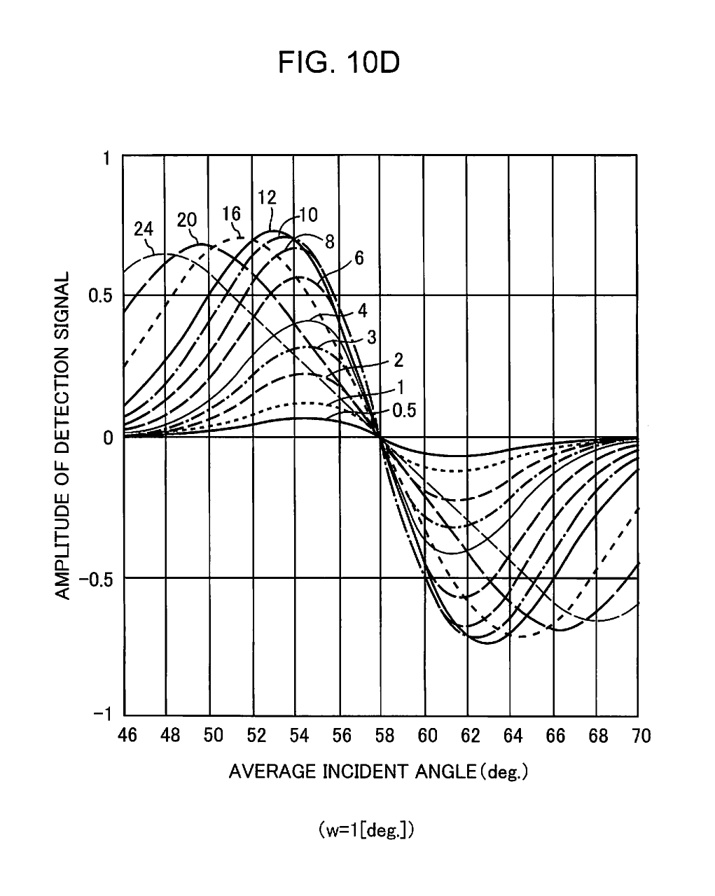

FIGS. 10A to 10D are graphs representing detection signals calculated on the basis of experimental results. The experiments carried out by the inventors are described with reference to FIGS. 9A to 10D.

### (Detecting Apparatus)

The inventors used a He—Ne laser as the light source 200A. Power of the He—Ne laser was 0.1 mW. The He—Ne laser emitted a laser beam having a wavelength of 633 nm. The laser beam was used as the excitation light PL. The laser beam had p-polarized light.

The inventors used a prism element as the prism 430, the prism element being formed from SF11 glass material. The prism element had a regular triangular prism shape.

The inventors used an Au thin film as the metal thin film 410A, the Au thin film being formed on SF11 glass substrate by a sputtering method. After the formation of the Au thin film, the inventors used refractive index matching liquid to firmly fix the SF11 glass substrate to the prism element. The Au thin film was 45 nm in thickness. The inventors spin-coated a polystyrene film on the Au thin film in order to prevent quenching of the fluorescence FL. The polystyrene film was 20 nm in thickness.

The inventors used a small container made of quartz glass as the specimen cell 420A. The inventors used a rubber ring to seal a gap between the container and the Au thin film. Accordingly, there was little liquid leakage between the container and the Au thin film. Two holes were formed in the container. The inventors fed liquid to the container and discharged the liquid from the container through these holes. The inventors used a peristaltic pump (not shown) for the supply and discharge of the liquid.

The inventors used a photomultiplier as the detector 510A. The inventors placed a band-pass filter between the container and the photomultiplier. The inventors used the band-pass filter to block a laser beam propagating from the container to the photomultiplier. Therefore, the fluorescence FL emitted from the detection target substances in the container selectively entered the photomultiplier.

The inventors used a frequency counter to measure a pulse generation frequency of photon pulses detected by the photomultiplier.

### (Specimen)

The inventors supplied carbonate buffer solution of biotinylated BSA (bovine serum albumin) to the container. Accordingly, the biotinylated BSA was firmly fixed on the polystyrene film.

The inventors then supplied PBS (phosphate-buffered saline) buffer solution of streptavidin to the container. Consequently, the streptavidin combined with the biotinylated BSA.

The inventors used biotinylated DNA as the detection target substances, the biotinylated DNA being labeled by Dy647 fluorescent agents. After the combination treatment between the streptavidin and the biotinylated BSA, the inventors fed the PBS buffer solution of the biotinylated DNA to the container. Consequently, the biotinylated DNA combined with the streptavidin near the Au thin film. The biotinylated DNA was 10 nM in concentration.

### (Measurement of Incident Angle Dependency)

The inventors actuated the adjusting mechanism 600E to measure amplitude of the fluorescence signal FLS while the inventors kept the galvanometer mirror 310 stationary. Whenever the holder plate 610 rotated by 0.5 deg., the inventors measured fluorescence intensity. The inventors plotted the measured fluorescence intensity on a graph to create a resonance curve. When the incident angle was 58 deg., the resonance curve indicated the maximum. A full width at half maximum w of the resonance curve was 3.3 deg. The resonance curve was approximate in a shape to a Gaussian curve.

### (Calculation of Detection Signal)

The inventors calculated a waveform of the detection signal DTS under modulation of the incident angle on the basis of results obtained from the measurement of the incident angle dependency.

The inventors approximated the Gaussian curve to the resonance curve. A relationship between the full width at half maximum w and a standard deviation σ of the Gaussian curve is represented by the following formula.

$$σ = \frac{w}{2 \sqrt{2 ln ( 2 )}} \qquad [ Math 3 ]$$

A resonance curve I(θ) approximated by the Gaussian curve is represented by the following formula. In the following formula, the sign “θ” represents an incident angle. The sign “θᵣₑₛ” represents a resonance angle.

$$I ( θ ) = exp [ - \frac{1}{2 {σ}^{2}} {( θ - {θ}_{res} )}^{2} ] \qquad [ Math 4 ]$$

A temporal change waveform m(t, θₐᵥ) of the incident angle is represented by the following formula. In the following formula, the sign “Δθ” represents modulation amplitude of the incident angle. The sign “θₐᵥ” represents an average incident angle. The sign “f” represents a modulation frequency. The sign “t” represents time.

$$m ( t , {θ}_{av} ) = \frac{Δ θ}{2} cos ( 2 π ft ) + {θ}_{av} \qquad [ Math 5 ]$$

The inventors substituted the temporal change waveform m(t, θₐᵥ) of the incident angle in the incident angle θ of the resonance curve I(θ) to obtain a temporal change waveform s(t, θₐᵥ) of the fluorescence signal FLS represented by the following formula.

$$s ( t , {θ}_{av} ) = exp [ - \frac{1}{2 {σ}^{2}} {( m ( t , {θ}_{av} ) - {θ}_{res} )}^{2} ] \qquad [ Math 6 ]$$

Multiplying the temporal change waveform s(t, θₐᵥ) of the fluorescence signal FLS with the temporal change waveform m(t, θₐᵥ) of the incident angle to extract a direct-current component is equal to subjecting the fluorescence signal FLS to synchronous detection using the modulation signal MDS. Magnitude Pₙ(θₐᵥ) of the detection signal is equivalent to a value obtained by integrating “s(t, θₐᵥ)×m(t, θₐᵥ)” over one cycle of modulation (c.f. the following formula).

[Math 7]

Pₙ(θₐᵥ)=∫₀^{1/f}s(t,θₐᵥ)·m(t,θₐᵥ)dt

FIGS. 10A to 10D are graphs showing the magnitude Pₙ(θₐᵥ) of the detection signal obtained under the resonance angle θₐᵥ of “58 deg.”. The graph of FIG. 10A is obtained under a condition that the full width at half maximum w of the resonance curve is “1 deg.”. The graph of FIG. 10B is obtained under a condition that the full width at half maximum w of the resonance curve is “2 deg.”. The graph of FIG. 10C is obtained under a condition that the full width at half maximum w of the resonance curve is “4 deg.”. The graph of FIG. 10D is obtained under a condition that the full width at half maximum w of the resonance curve is “8 deg.”.

Each of the graphs in FIG. 10A to FIG. 10D shows curves. Numerical values (i.e. 0.5, 1, 2, 3, 4, 6, 8, 10, 12, 16, 20 and 24) added on each of curves represent values of the modulation amplitude Δθ.

As described in the context of the fourth embodiment, in order to sensitively measure fluorescence intensity, it is preferable to obtain a large detection signal. It is figured out from the graphs of FIGS. 10A to 10D that there is a suitable range of the modulation amplitude Δθ for obtaining a large detection signal.

As shown in FIG. 10A, if the full width at half maximum w is “1 deg.”, a large peak of the detection signal is obtained under a relationship of “1 deg.≦Δθ≦3 deg.”.

As shown in FIG. 10B, if the full width at half maximum w is “2 deg.”, a large peak of the detection signal is obtained under a relationship of “2 deg.≦Δθ≦6 deg.”.

As shown in FIG. 10C, if the full width at half maximum w is “4 deg.”, a large peak of the detection signal is obtained under a relationship of “4 deg.≦Δθ≦12 deg.”.

As shown in FIG. 10D, if the full width at half maximum w is “8 deg.”, a large peak of the detection signal is obtained under a relationship of “8 deg.≦Δθ≦24 deg.”.

It is figured out from the knowledge obtained from FIGS. 10A to 10D that a large detection signal is obtained if the galvanometer mirror 310 varies the incident angle θ at magnitude which is no less than the full width at half maximum of the fluorescence signal FLS and three times or less as large as the full width at half maximum when the driving motor 620 rotates the holder plate 610 (w≦θ≦3w) under a stop of the modulating mechanism 300A.

### Tenth Embodiment

An actual incident angle may deviate from a setting value determined for an incident angle because of mechanical errors of a detecting apparatus. The errors between the actual incident angle and the setting value cause errors in calculation for an amount of detection target substances. Techniques for making the errors between the actual incident angle and the setting value less influential to calculation of an amount of detection target substances are described in the tenth embodiment.

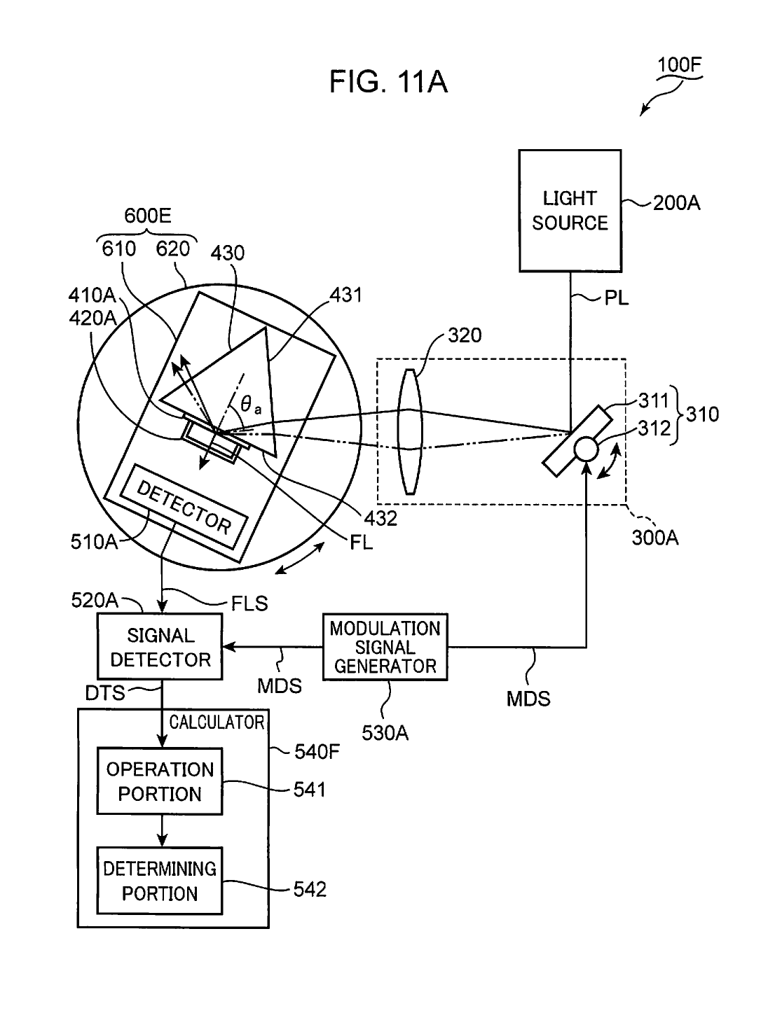

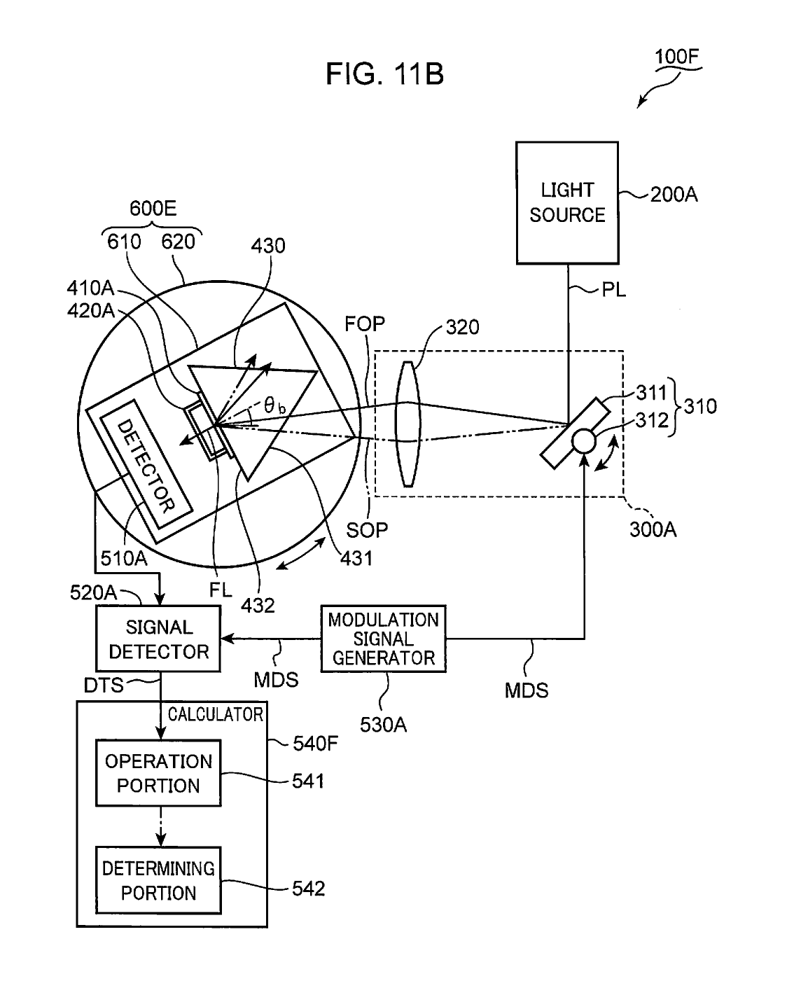

FIGS. 11A and 11B are schematic views of a detecting apparatus 100F according to the tenth embodiment. The detecting apparatus 100F is described with reference to FIGS. 11A and 11B. Reference numerals and signs used in common between the eighth and tenth embodiments mean that elements denoted by the common reference numerals and signs have the same functions as the eighth embodiment. Therefore, the description of the eighth embodiment is applicable to these elements.

Like the eighth embodiment, the detecting apparatus 100F includes the light source 200A, the modulating mechanism 300A, the metal thin film 410A, the specimen cell 420A, the prism 430, the detector 510A, the signal detector 520A, the modulation signal generator 530A and the adjusting mechanism 600E. The description of the eighth embodiment is applied to these elements.

The detecting apparatus 100F further includes a calculator 540F. The calculator 540F includes an operation portion 541 and a determining portion 542. The detection signal DTS is output from the signal detector 520A to the operation portion 541. The operation portion 541 uses the detection signal DTS to perform integral operation. Results of the integral operation are output from the operation portion 541 to the determining portion 542. The determining portion 542 determines an amount of the detection target substances on the basis of the results of the integral operation.

A user may actuate both of the driving motors 312, 620 to measure an amount of the detection target substances. The user may actuate the driving motor 620 to change an average incident angle from an average incident angle θ₀ sufficiently away from the resonance angle θᵣₑₛ to the predetermined average incident angle θₐᵥ. A value of the detection signal DTS is about “0” at the average incident angle θ₀. If the value of the detection signal DTS at the average incident angle θₐᵥ is represented by the sign “Pₙ”, an integrated value Pᵢ calculated by the operation portion 541 is represented by the following formula.

[Math 8]

Pᵢ=∫_{θ}_{₀}^{θ}^{ₐᵥ}Pₙdθₐᵥ

The determining portion 542 may store calibration curve data in advance, the calibration curve data representing a relationship between the integrated value Pᵢ and an amount of the detection target substances. The determining portion 542 may compare the integrated value Pᵢ with the calibration curve data to determine an amount of the detection target substances. Creation techniques for the calibration curve data may comply with the method described in the context of the fourth embodiment. Principles of the present embodiment are not limited to a specific technique for creating the calibration curve data.

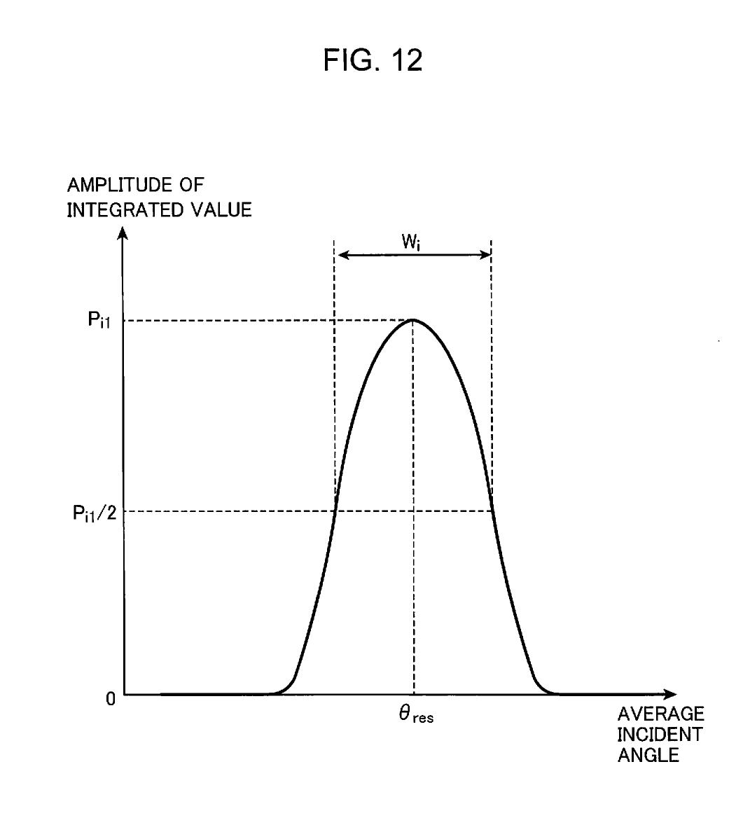

FIG. 12 is a graph obtained from the aforementioned formula. Superior characteristics of the principles of the present embodiment to the conventional techniques are described with reference to FIGS. 11A to 12 and 16.

The abscissa of the graph in FIG. 12 represents the average incident angle. The ordinate of the graph in FIG. 12 represents the integrated value represented by the aforementioned formula. Like the graph of FIG. 16, a peak of the integrated value appears at the resonance angle θᵣₑₛ.

In FIG. 12, a full width at half maximum of a curve is represented by the sign “wᵢ”.

The full width at half maximum w of the curve of the graph in FIG. 16 is defined by an amplitude position of a detection signal which has a value obtained by adding the offset component P_{off} to a half value of a difference value between the maximum Pₚ₂ of the detection signal and the offset component P_{off} (i.e. ((Pₚ₂−P_{off})/2+P_{off})).

When the graphs of FIGS. 12 and 16 are compared, it is figured out that the full width at half maximum wᵢ is larger than the full width at half maximum w. This means that deviation of an actual incident angle from a setting value determined for an incident angle becomes less influential to a measurement value obtained by the detecting apparatus 100F, in comparison with the conventional techniques.

### Eleventh Embodiment

The inventors used the knowledge described in the context of the ninth embodiment to identify an appropriate modulation amplitude range for a detecting apparatus having an integrating function. Appropriate setting techniques for a modulation range of an incident angle are described in the eleventh embodiment.

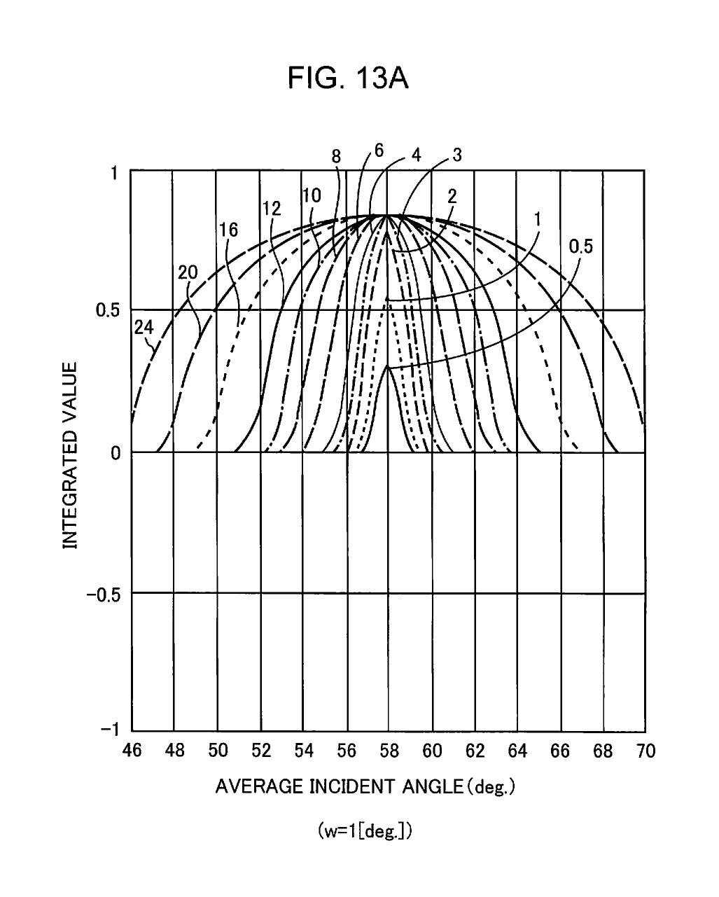

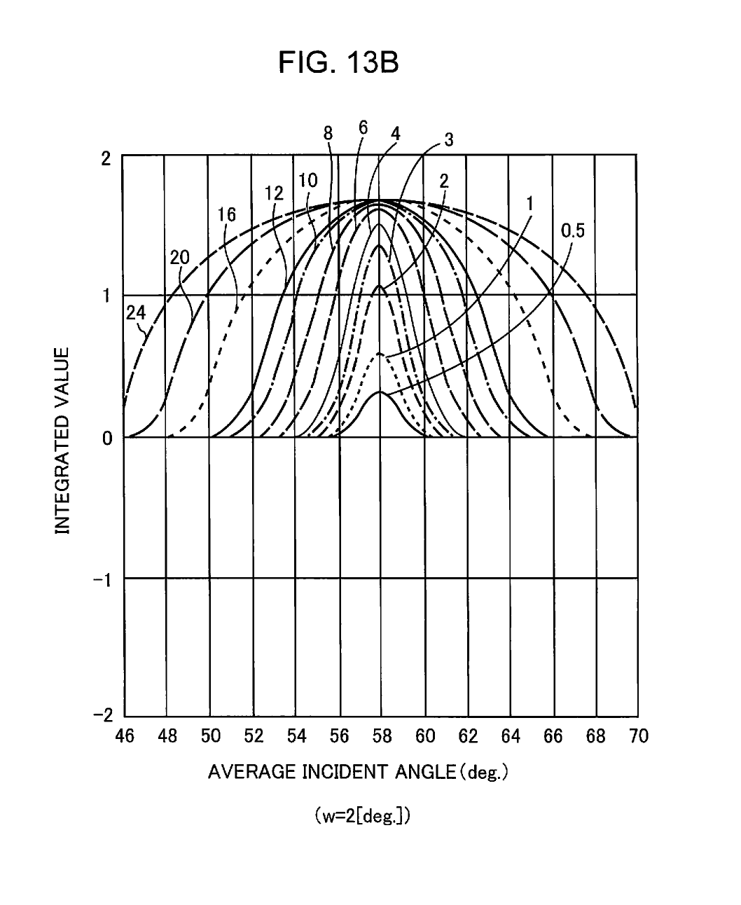

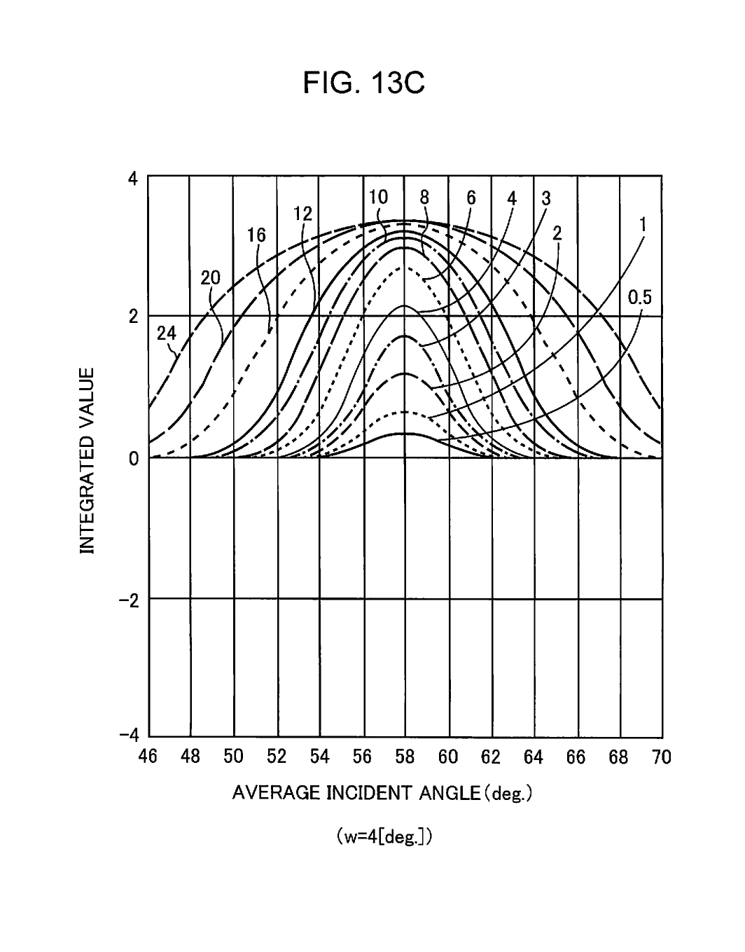

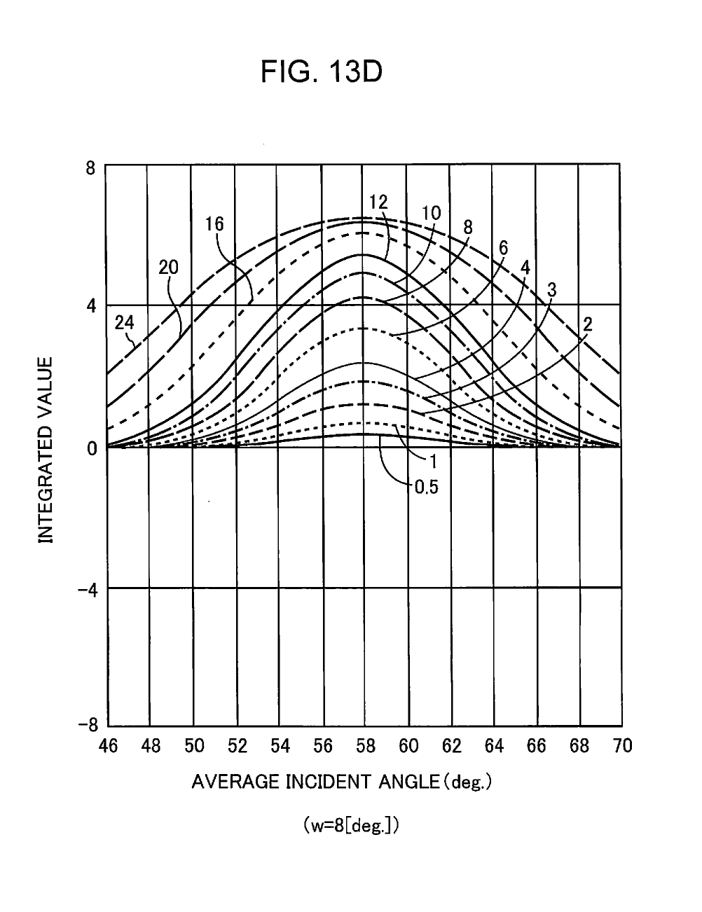

FIGS. 13A to 13D are graphs showing detection signals calculated on the basis of experimental results. The appropriate setting techniques for a modulation range of an incident angle are described with reference to FIGS. 11A, 11B, 13A to 13D.

The following formula represents an integrated value Pᵢ(θₐᵥ) of the amplitude Pₙ(θₐᵥ) of the detection signal described in the context of the seventh embodiment.

[Math 9]

Pᵢ(θₐᵥ)=∫₀^{θ}^{ₐᵥ}Pₙ(θₐᵥ)dt

FIGS. 13A to 13D are graphs showing the integrated value Pᵢ(θₐᵥ) obtained under the resonance angle θₐᵥ of “58 deg.”. The graph of FIG. 13A is obtained under a condition that the full width at half maximum w of the fluorescence signal FLS is “1 deg.”. The graph of FIG. 13B is obtained under a condition that the full width at half maximum w of the fluorescence signal FLS is “2 deg.”. The graph of FIG. 13C is obtained under a condition that the full width at half maximum w of the fluorescence signal FLS is “4 deg.”. The graph of FIG. 13D is obtained under a condition that the full width at half maximum w of the fluorescence signal FLS is “8 deg.”.

Each of the graphs in FIGS. 13A to 13D shows curves. Numerical values (i.e. 0.5, 1, 2, 3, 4, 6, 8, 10, 12, 16, 20 and 24) added on each of the curves represent values of the modulation amplitude Δθ.

A large integrated value Pᵢ(θₐᵥ) means that florescence intensity is sensitively measured. It is figured out from the graphs of FIGS. 13A to 13D that there is a suitable range of the modulation amplitude Δθ for obtaining the large detection signal.

As shown in FIG. 13A, if the full width at half maximum w is “1 deg.”, a large peak of the integrated value Pᵢ(θₐᵥ) is obtained under a relationship of “Δθ≧2 deg.”.

As shown in FIG. 13B, if the full width at half maximum w is “2 deg.”, a large peak of the integrated value Pᵢ(θₐᵥ) is obtained under a relationship of “Δθ≧4 deg.”.

As shown in FIG. 13C, if the full width at half maximum w is “4 deg.”, a large peak of the integrated value Pᵢ(θₐᵥ) is obtained under a relationship of “Δθ≧8 deg.”.

As shown in FIG. 13D, if the full width at half maximum w is “8 deg.”, a large peak of the integrated value Pᵢ(θₐᵥ) is obtained under a relationship of “Δθ≧16 deg.”.

It is figured out from the graphs of FIGS. 13A to 13D that the full width at half maximum of the integrated value Pᵢ(θₐᵥ) increases in response to an increase in the modulation amplitude Δθ.

It is figured out from the knowledge obtained from FIGS. 13A to 13D that a large detection signal is obtained if the galvanometer mirror 310 varies the incident angle θ at magnitude which is twice or more as large as the full width at half maximum of the fluorescence signal FLS when the driving motor 620 rotates the holder plate 610 (θ≧2w) under a stop of the modulating mechanism 300A.

### Twelfth Embodiment

The detecting apparatus described in the context of the eighth embodiment mechanically adjusts an average incident angle. Alternatively, the average incident angle may be electrically adjusted. In this case, a mechanical structure of a detecting apparatus is simpler than the detecting apparatus described in the context of to the eighth embodiment is. A detecting apparatus configured to electrically adjust an average incident angle is described in the twelfth embodiment.

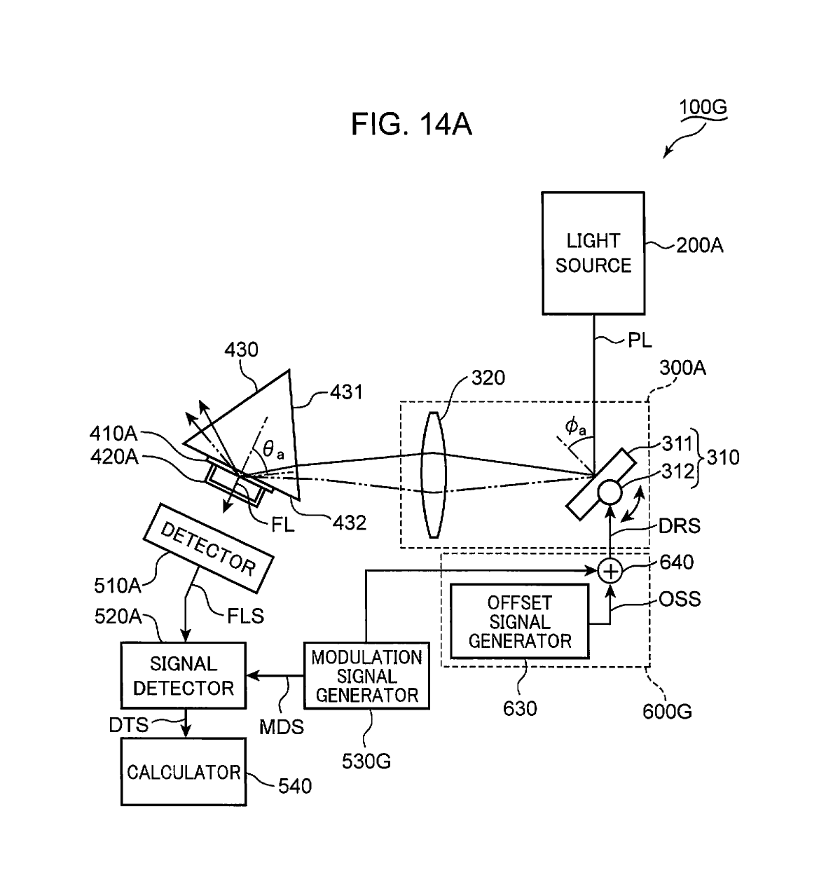

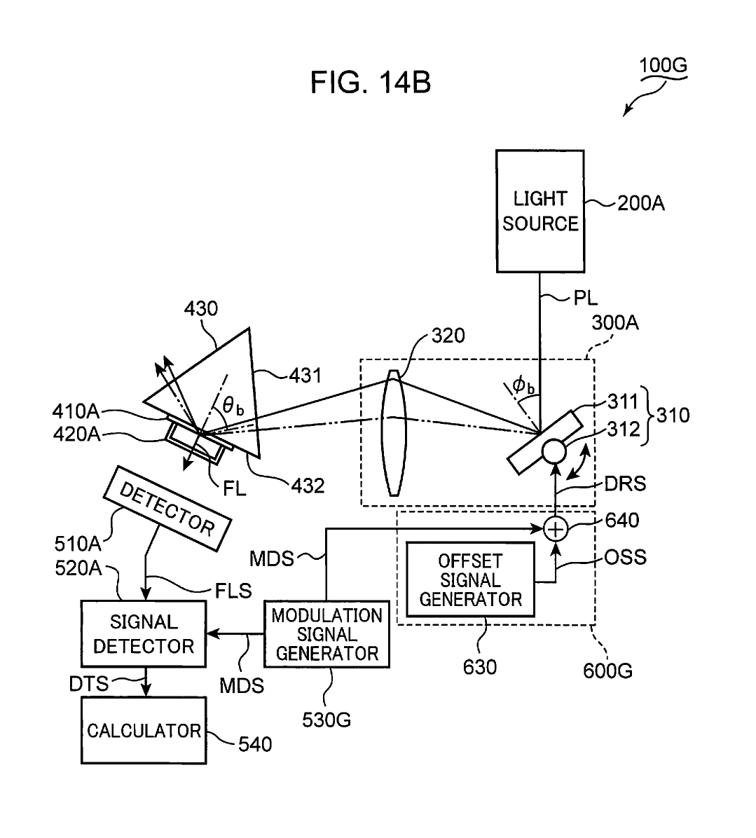

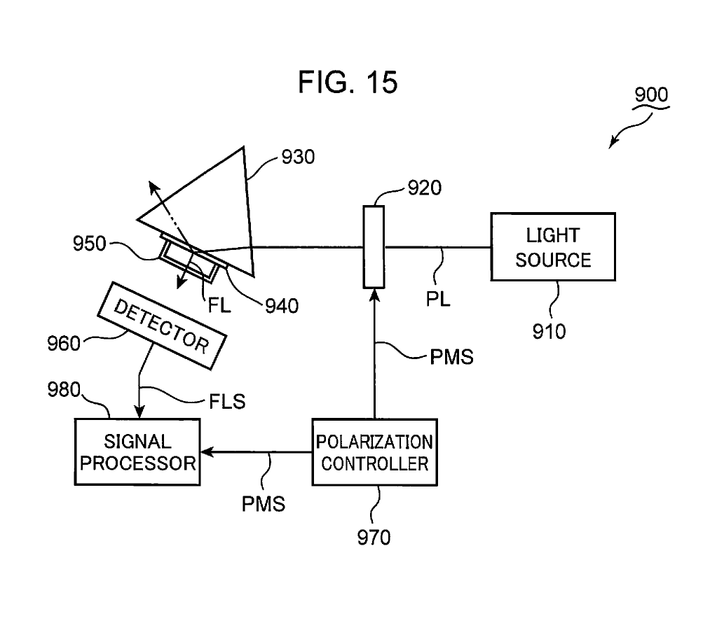

FIGS. 14A and 14B are schematic views of the detecting apparatus 100G according to the twelfth embodiment. The detecting apparatus 100G is described with reference to FIGS. 8, 14A and 14B. Reference numerals and signs used in common between the third and twelfth embodiments mean that elements denoted by the common reference numerals and signs have the same functions as the third embodiment. Therefore, the description of the third embodiment is applicable to these elements.

Like the third embodiment, the detecting apparatus 100G includes the light source 200A, the modulating mechanism 300A, the metal thin film 410A, the specimen cell 420A, the prism 430, the detector 510A, the signal detector 520A and the calculator 540. The description of the third embodiment is applied to these elements.

The detecting apparatus 100G further includes a modulation signal generator 530G and an adjuster 600G. The adjuster 600G corresponds to the adjuster 600 described with reference to FIG. 8.

The adjuster 600G includes an offset signal generator 630 and an adder 640. The offset signal generator 630 generates an offset signal OSS. The offset signal OSS is output from the offset signal generator 630 to the adder 640.

Like the third embodiment, the modulation signal generator 530G outputs the modulation signal MDS to the signal detector 520A. Unlike the third embodiment, the modulation signal generator 530G outputs the modulation signal MDS to the adder 640.

The adder 640 adds the offset signal OSS to the modulation signal MDS to generate the driving signal DRS. Accordingly, an average incident angle represented by the driving signal DRS becomes a value obtained by increasing or reducing an average incident angle by an angle which is represented by the offset signal OSS, the average incident angle being defined by the modulation signal MDS.

The driving signal DRS is output from the adder 640 to the driving motor 312 of the galvanometer mirror 310. The driving motor 312 causes a bidirectional rotary motion of the reflective mirror 311 in response to the driving signal DRS.

The detecting apparatus 100G may use the offset signal OSS to adjust an average incident angle of the excitation light PL on the metal thin film 410A.

As shown in FIG. 14A, if an average incident angle of the excitation light PL on the galvanometer mirror 310 is set to “φₐ”, the average incident angle of the excitation light PL on the metal thin film 410A is “θₐ”. The offset signal generator 630 shown in FIG. 14A generates the offset signal OSS so that the average incident angle of the excitation light PL on the galvanometer mirror 310 is set to “φₐ”. Therefore, the offset signal OSS may cooperate with the modulation signal MDS to define a variation range of an incident angle on the metal thin film 41 OA, the variation range centering on the average incident angle θₐ. In this embodiment, the adjustment signal is exemplified by the offset signal OSS. The adjustment signal generator is exemplified by the offset signal generator 630.

As shown in FIG. 14B, if the average incident angle of the excitation light PL on the galvanometer mirror 310 is set to “φ_{b}”, the average incident angle of the excitation light PL on the metal thin film 410A is “θ_{b}”. The offset signal generator 630 as shown in FIG. 14B generates the offset signal OSS so that the average incident angle of the excitation light PL on the galvanometer mirror 310 is set to “φ_{b}”. Therefore, the offset signal OSS may cooperate with the modulation signal MDS to define a variation range of an incident angle on the metal thin film 41 OA, the variation range centering on the average incident angle θ_{b}.

The principles of the aforementioned various embodiments may be combined as appropriate according to applications of detecting apparatuses.

The techniques about the exemplary detecting apparatuses described in the context of the various embodiments mainly have the following features.

A detecting apparatus according to one aspect of the aforementioned embodiments includes: a light source configured to emits excitation light; a storage portion in which a specimen is stored; a metal film which receives the excitation light to cause evanescent light for illuminating the specimen; a modulator configured to modulate an incident angle of the excitation light on the metal film; a driver configured to generate a driving signal for driving the modulator; a detector configured to output a fluorescence signal in correspondence to intensity of fluorescence generated from the specimen under irradiation of the evanescent light; and an extractor configured to extract a signal component from the fluorescence signal, the signal component deriving from the specimen. The incident angle changes in response to a change of the driving signal. The extractor extracts a synchronous signal component as the signal component, the synchronous signal component changing in synchronization with the change of the driving signal.

According to the aforementioned configuration, since the extractor extracts a synchronous signal component as the signal component, the synchronous signal component changing in synchronization with the change of the driving signal, a light component which fails to be affected by a change in the incident angle is likely to be excluded from the extracted signal component. Therefore, the detecting apparatus may accurately measure the intensity of the fluorescence from the specimen illuminated by the evanescent light.

In the aforementioned configuration, the detecting apparatus may further include a prism including a first surface, on which the excitation light is made incident, and a second surface, to which the metal film is attached. The metal film may be situated between the storage portion and the second surface.

According to the aforementioned configuration, since the excitation light is appropriately guided to the metal film by the prism, the metal film may generate the evanescent light. Since the metal film is situated between the storage portion and the second surface, the reflector defines a first optical path, along which the excitation light propagates when the incident angle is set to a first incident angle, and a second optical path, along which the excitation light propagates when the incident angle is set to a second incident angle different from the first incident angle, so that the evanescent light may appropriately irradiate the specimen.

In the aforementioned configuration, the modulator may include a reflector configured to reflect the excitation light and a lens portion situated between the reflector and the prism. The reflector may change a reflection direction of the excitation light in response to the driving signal. The excitation light may be refracted by the lens portion to propagate toward a predetermined position on the metal film.

According to the aforementioned configuration, while the reflector changes the reflection direction of the excitation light in response to the driving signal, the excitation light is refracted by the lens portion to propagate toward the predetermined position on the metal film. Therefore, the detecting apparatus may accurately measure the intensity of the fluorescence from the specimen illuminated by the evanescent light.

In the aforementioned configuration, the reflector may define a first optical path, along which the excitation light propagates when the incident angle is set to a first incident angle, and a second optical path, along which the excitation light propagates when the incident angle is set to a second incident angle different from the first incident angle. The second optical path may get away from the first optical path as the excitation light approaches the lens portion from the reflector whereas the second optical path may get closer to the first optical path as the excitation light approaches the metal film from the lens portion.

According to the aforementioned configuration, since the second optical path gets away from the first optical path as the excitation light approaches the lens portion from the reflector, the reflector may largely change the incident angle. Since the second optical path gets closer to the first optical path as the excitation light approaches the metal film from the lens portion, the excitation light may propagate toward the predetermined position on the metal film. Therefore, the detecting apparatus may accurately measure the intensity of the fluorescence from the specimen illuminated by the evanescent light.

In the aforementioned configuration, the lens portion may include a first lens, on which the excitation light reflected by the reflector is made incident, and a second lens situated between the first lens and the prism. The reflector may define a first optical path, along which the excitation light propagates when the incident angle is set to a first incident angle, and a second optical path, along which the excitation light propagates when the incident angle is set to a second incident angle different from the first incident angle. An angular difference between the first and second optical paths may be smaller in a propagation section from the first lens to the second lens than a propagation section from the reflector to the first lens.

According to the aforementioned configuration, since the lens portion includes the first and second lenses, a designer may design the detecting apparatus without a lens element having an excessively high refractive index.

In the aforementioned configuration, the modulator may include a first reflective mirror, which reflects the excitation light emitted from the light source, and a second reflective mirror, which reflects the excitation light after the first reflective mirror. When the incident angle is set to a first incident angle, the first and second reflective mirrors may define a first optical path in cooperation with each other. When the incident angle is set to a second incident angle different from the first incident angle, the first and second reflective mirrors may define a second optical path in cooperation with each other. The second optical path may get away from the first optical path as the excitation light approaches the second reflective mirror from the first reflective mirror whereas the second optical path may get closer to the first optical path as the excitation light approaches the metal film from the second reflective mirror.

According to the aforementioned configuration, since the second optical path gets away from the first optical path as the excitation light approaches the second reflective mirror from the first reflective mirror, the incident angle may be largely changed. Since the second optical path gets closer to the first optical path as the excitation light approaches the metal film from the second reflective mirror, the excitation light may propagate toward the predetermined position on the metal film. Therefore, the detecting apparatus may accurately measure the intensity of the fluorescence from the specimen illuminated by the evanescent light.

In the aforementioned configuration, the detecting apparatus may further include an adjuster configured to adjust a central value of a variation range of the incident angle.

According to the aforementioned configuration, since the adjuster adjusts the central value of the variation range of the incident angle, the detecting apparatus may accurately measure the intensity of the fluorescence from the specimen illuminated by the evanescent light.

In the aforementioned configuration, the adjuster may include an adjustment signal generator configured to generate an adjustment signal for adjusting the central value. The adjustment signal may define the variation range in cooperation with the driving signal.

According to the aforementioned configuration, since the adjuster electrically adjusts the central value of the variation range of the incident angle, the detecting apparatus may accurately measure the intensity of the fluorescence from the specimen illuminated by the evanescent light.

In the aforementioned configuration, the adjuster may include a holder, which holds the prism, the metal film, the storage portion and the detector, and a rotary portion, which rotates the holder. The rotary portion may rotate the holder to change the central value.

According to the aforementioned configuration, since the adjuster mechanically adjusts the central value of the variation range of the incident angle, the detecting apparatus may accurately measure the intensity of the fluorescence from the specimen illuminated by the evanescent light.

In the aforementioned configuration, the modulator may vary the incident angle within a variation width which is no less than a full width at half maximum of the fluorescence signal when the rotary portion rotates the holder under a stop of the modulator.

According to the aforementioned configuration, since the incident angle varies in an appropriate variation range, the detecting apparatus may accurately measure the intensity of the fluorescence from the specimen illuminated by the evanescent light.

In the aforementioned configuration, the variation width may be three times or less as large as the full width at half maximum.

According to the aforementioned configuration, since the incident angle varies within an appropriate variation range, the detecting apparatus may accurately measure the intensity of the fluorescence from the specimen illuminated by the evanescent light.

In the aforementioned configuration, the detecting apparatus may further include a calculating portion configured to calculate an amount of detection target substances in the specimen from the signal component.

According to the aforementioned configuration, the amount of the detection target substances in the specimen is appropriately calculated from the signal component.

In the aforementioned configuration, the calculating portion may include an operation portion, which applies integral operation to the signal component, and a determining portion, which determines the amount of the detection target substances on the basis of a result of the integral operation.

According to the aforementioned configuration, the amount of the detection target substances in the specimen is appropriately determined by the integral operation for the signal component.

In the aforementioned configuration, the modulator may change the incident angle within a variation width which is twice or more as large as a full width at half maximum of the fluorescence signal when the rotary portion rotates the holder under a stop of the modulator.

According to the aforementioned configuration, since the incident angle varies within an appropriate variation range, the detecting apparatus may accurately measure the intensity of the fluorescence from the specimen illuminated by the evanescent light.

In the aforementioned configuration, the signal component may get closer to a peak value as the incident angle gets closer to the central value.

According to the aforementioned configuration, since the signal component gets closer to the peak value as the incident angle gets closer to the central value, the detecting apparatus may accurately measure the intensity of the fluorescence from the specimen illuminated by the evanescent light.

### INDUSTRIAL APPLICABILITY

The principles of the aforementioned embodiments are applicable to various technical fields (e.g. biotechnology) in which it is requested to detect a very small amount of substances. The aforementioned technical principles may be applied not only to the biotechnology field but also to measurement techniques used in environment fields.

1. A detecting apparatus comprising:
a light source configured to emit excitation light;
a storage portion in which a specimen is stored;
a metal film which receives the excitation light to cause evanescent light for illuminating the specimen;
a modulator configured to modulate an incident angle of the excitation light on the metal film;
a driver configured to generate a driving signal for driving the modulator;
a detector configured to output a fluorescence signal in correspondence to intensity of fluorescence generated from the specimen under irradiation of the evanescent light; and
an extractor which extracts a signal component from the fluorescence signal, the signal component deriving from the specimen,
wherein the incident angle changes in response to a change of the driving signal, and
wherein the extractor extracts a synchronous signal component as the signal component, the synchronous signal component changing in synchronization with the change of the driving signal.

2. The detecting apparatus according to claim 1, further comprising
a prism including a first surface, on which the excitation light is made incident, and a second surface, to which the metal film is attached,
wherein the metal film is situated between the storage portion and the second surface.

3. The detecting apparatus according to claim 2,
wherein the modulator includes a reflector configured to reflect the excitation light and a lens portion situated between the reflector and the prism,
wherein the reflector changes a reflection direction of the excitation light in response to the driving signal, and
wherein the excitation light is refracted by the lens portion to propagate toward a predetermined position on the metal film.

4. The detecting apparatus according to claim 3,
wherein the reflector defines a first optical path, along which the excitation light propagates when the incident angle is set to a first incident angle, and a second optical path, along which the excitation light propagates when the incident angle is set to a second incident angle different from the first incident angle,
wherein the second optical path gets away from the first optical path as the excitation light approaches the lens portion from the reflector whereas the second optical path gets closer to the first optical path as the excitation light approaches the metal film from the lens portion.

5. The detecting apparatus according to claim 3,
wherein the lens portion includes a first lens, on which the excitation light reflected by the reflector is made incident, and a second lens situated between the first lens and the prism,
wherein the reflector defines a first optical path, along which the excitation light propagates when the incident angle is set to a first incident angle, and a second optical path, along which the excitation light propagates when the incident angle is set to a second incident angle different from the first incident angle, and
wherein an angular difference between the first and second optical paths is smaller in a propagation section from the first lens to the second lens than a propagation section from the reflector to the first lens.

6. The detecting apparatus according to claim 2,
wherein the modulator includes a first reflective mirror, which reflects the excitation light emitted from the light source, and a second reflective mirror, which reflects the excitation light after the first reflective mirror,
wherein the first and second reflective mirrors define a first optical path in cooperation with each other when the incident angle is set to a first incident angle,
wherein the first and second reflective mirrors define a second optical path in cooperation with each other when the incident angle is set to a second incident angle different from the first incident angle, and
wherein the second optical path gets away from the first optical path as the excitation light approaches the second reflective mirror from the first reflective mirror whereas the second optical path gets closer to the first optical path as the excitation light approaches the metal film from the second reflective mirror.

7. The detecting apparatus according to claim 2, further comprising an adjuster configured to adjust a central value of a variation range of the incident angle.

8. The detecting apparatus according to claim 7,
wherein the adjuster includes an adjustment signal generator configured to generate an adjustment signal for adjusting the central value, and
wherein the adjustment signal defines the variation range in cooperation with the driving signal.

9. The detecting apparatus according to claim 7,
wherein the adjuster includes a holder, which holds the prism, the metal film, the storage portion and the detector, and a rotary portion, which rotates the holder, and
wherein the rotary portion rotates the holder to change the central value.

10. The detecting apparatus according to claim 9,
wherein the modulator varies the incident angle within a variation width which is no less than a full width at half maximum of the incident angle when the rotary portion rotates the holder under a stop of the modulator.

11. The detecting apparatus according to claim 10,
wherein the variation width is three times or less as large as the full width at half maximum.

12. The detecting apparatus according to claim 9, further comprising a calculating portion configured to calculate an amount of detection target substances in the specimen from the signal component.

13. The detecting apparatus according to claim 12,
wherein the calculating portion includes an operation portion, which applies integral operation to the signal component, and a determining portion, which determines the amount of the detection target substances based on a result of the integral operation.

14. The detecting apparatus according to claim 13,
wherein the modulator varies the incident angle within a variation width which is twice or more as large as a full width at half maximum of the incident angle when the rotary portion rotates the holder under a stop of the modulator.

15. The detecting apparatus according to claim 7,
wherein the signal component gets closer to a peak value as the incident angle gets closer to the central value.
